(19) United States
(12) Patent Application Publication
(10) Pub. No.: US 2026/0301101 A1
(43) Pub. Date: Oct. 1, 2026

(54) SYSTEMS, VEHICLES, AND METHODS FOR PROVIDING TRANSPORTATION OPTIONS

(71) Applicant: Adeia Guides Inc., San Jose, CA (US)

(72) Inventors: Aldis Sipolins, Somerville, MA (US); Serhad Doken, Bryn Mawr, PA (US); Tao Chen, Palo Alto, CA (US)

(21) Appl. No.: 19/094,422

(22) Filed: Mar. 28, 2025

(51) Int. Cl. G06Q 50/47; G01C 21/34

(52) U.S. Cl. CPC G06Q 50/47; G01C 21/3423

(57) ABSTRACT

Systems, vehicles, and methods are disclosed herein for providing transportation options. In relation to a ride request to transport a user from a first location to a second location, and a desired arrival time for the user to arrive at the second location, the system may identify a plurality of estimated transportation durations, each respectively corresponding to a drop-off location at or within a proximity of the second location, and each enabling the user to arrive at the second location by the desired arrival time. The system may select a first estimated transportation duration associated with a first drop-off location, based on an estimated transportation duration to transport the user from the first location to the first drop-off location and an estimated transportation duration for a second mode of transportation to enable the user to arrive at the second location from the first drop-off location.

### BACKGROUND

The present disclosure is directed to systems and methods for providing transportation options.

### SUMMARY

Ride hailing/ride sharing (RHRS) platforms have significantly grown in popularity in recent years. For example, passengers can use an RHRS application on their smartphone to specify a pickup location and a drop-off location, and request a vehicle to transport them from the pickup location to drop-off location for a fee.

In one approach, the RHRS platform provides a navigation route that instructs a driver of the vehicle to bring passengers directly to a given address or business (specified by the passenger as the desired destination), regardless of the driver's next destination or when a passenger actually needs to arrive at their destination. For example, a passenger who is late for a dinner reservation (or theatre show time) would likely want to be dropped off directly in front of the restaurant to get there as quickly as possible. If the same passenger was instead early for dinner, they would not have the same time constraint. In this case, the driver may waste time navigating to the front of the restaurant when they could have dropped them off at a more convenient location, which would save the driver time while not significantly inconveniencing the passenger. Even if there is no time constraint, dropping a passenger off around the corner or up the block may save the driver more time than it costs the passenger. For example, a driver dropping a passenger off at a movie theater may find themselves having to traverse a crowded one-way street to navigate to the front of the movie theatre, which may put them in the opposite direction of their drive home, whereas dropping the passenger off around the corner from the movie theater may add a few seconds to the passenger's walk but would save an extra 5 minutes for the driver.

Extra time spent driving a passenger to their destination often acts as a drain on resources, such as fuel for the vehicle and additional wear and tear on the vehicle. Further, in the case of RHRS services, such extra time may result in higher fees for passengers, and detract from the user experience for both driver and passenger. Moreover, the driver could have picked up another passenger in the meantime and that passenger could have saved time and/or had more options while they are requesting a ride share vehicle. For at least these reasons, there is a need for techniques to enable a RHRS platform and/or a navigation system to consider desired passenger arrival time, and/or the driver's subsequent destinations, when selecting a drop off location. Moreover, there is a need for providing an improved user interface for efficiently providing a user with an option for selecting a type of ride reflecting their willingness to walk from a drop-off location to their destination, and/or incentivizing the user to select such option, to enhance the efficiency of pickup and drop-off of passengers in the RHRS platform.

To help address these problems, systems, vehicles, and methods are disclosed herein for improving the efficiency of drop-off and pickup navigation for transportation platforms, and providing an improved interface for users, e.g., reflecting their willingness to walk from a drop-off location to their destination. In some embodiments, the disclosed systems, vehicles, and methods may be configured to receive, from a device, a ride request to transport a user from a first location to a second location, and determine a desired arrival time for the user to arrive at the second location. A plurality of estimated transportation times to transport the one or more users from the first location to the second location may be identified. Such plurality of estimated transportation times may respectively correspond to one or more drop-off locations at or within a proximity of the second location, and each of the plurality of estimated transportation durations may be based at least in part on a first mode of transportation associated with the ride request transporting the user from the first location to the respective drop-off location and enable the user to arrive at the second location by the desired arrival time.

The disclosed systems, vehicles, and methods may be configured to select a first estimated transportation time of the plurality of transportation times which is associated with a first drop-off location of the plurality of drop-off locations, and which is based at least in part on an estimated transportation duration for the first mode of transportation to transport the user from the first location to the first drop-off location and an estimated transportation duration for a second mode of transportation to enable the user to arrive at the second location from the first drop-off location. The estimated transportation duration for the second mode of transportation associated with the first estimated transportation duration exceeds an estimated transportation duration for the second mode of transportation associated with a second estimated transportation duration of the plurality of estimated transportation durations. The disclosed systems, vehicles, and methods may, based at least in part on the selecting, cause the device to display an option corresponding to the first estimated transportation time. The disclosed systems, vehicles, and methods may further, based at least in part on receiving selection of the option, cause the device to display an indication of a vehicle assigned to the ride request to pick up the user at the first location and execute a transportation route to transport the user to the first drop-off location associated with the first estimated transportation time

Such aspects may help conserve resources (e.g., fuel and vehicle wear-and-tear) by taking into account a willingness of a user to utilize a second mode of transportation (such as, for example, walk, e.g., to help avoid a situation where a driver navigates to an inconvenient drop off/pickup location (e.g., one-way, limited access) that adds 5 minutes to the drive home (or the next RHRS destination) while only saving the passenger 2 minutes of walking). Moreover, such features may take into account a desired passenger arrival time, and/or the driver's subsequent destinations, when selecting a drop off location, and present an improved interface to the user including an option to select a type of ride that reflects the user's willingness to walk (e.g., by such ride having a relatively lower cost compared to other types of rides, to incentivize the user to select such ride and help contribute to a more efficient transportation platform). For example, the user may accept a delay in their arrival time (but still prior to the desired arrival time), since they are willing to walk, and such ride may be discounted to the user. In some embodiments, the desired arrival time 108 may be determined implicitly (e.g., based on user emails, without explicit user input in the transportation platform of the desired arrival time) or may be explicitly set by the user in the transportation platform. In some embodiments, the disclosed systems, vehicles, and methods may be configured to perform the techniques disclosed herein based at least in part on determining a current trip corresponds to a certain a trip type (e.g., pickup and drop off at a destination, as opposed to a “park at destination trip type”).

In some embodiments, the disclosed systems, vehicles, and methods may be configured to predict a pickup location for a predicted subsequent ride request, wherein the vehicle is predicted to navigate to the predicted pickup location after the first mode of transportation associated with the ride request is completed. The disclosed systems, vehicles, and methods may be configured to cause the device to display the selectable option corresponding to the first estimated transportation duration based at least in part on determining that an estimated travel time for the vehicle to travel from the first drop-off location to the predicted pickup location is less than an estimated travel time for the vehicle to travel from a second drop-off location, associated with the second estimated transportation duration, to the predicted pickup location.

In some embodiments, the disclosed systems, vehicles, and methods may be configured to, while the vehicle is transporting the user to the first drop-off location, identify a pickup location for a subsequent ride request, where the vehicle is to navigate to the pickup location after the vehicle transportation of the user associated with the ride request is completed. The disclosed systems, vehicles, and methods may be configured to modify the transportation route to indicate that the user is to be dropped off at a second drop-off location instead of the first drop-off location, based at least in part on determining that an estimated travel time for the vehicle to travel from the second drop-off location to the pickup location for the subsequent ride request is less than an estimated travel time for the vehicle to travel from the first drop-off location to the pickup location for the subsequent ride request.

In some embodiments, the user is a first user, and the ride request is further associated with a second user to be picked up at the first location with the first user and dropped off at a third location different from the second location, the method further comprising selecting the first estimated transportation duration from the plurality of estimated transportation durations based at least in part on determining that an estimated transportation duration from the first drop-off location to the third location is less than an estimated transportation duration from the other drop-off locations associated with the other of the plurality of transportation durations to the third location. For example, the user may be permitted to select from various different drop-off locations, with varying transportation time estimates and varying vehicle travel times and varying walking times to arrive at the destination.

In some embodiments, the first mode of transportation corresponds to a vehicle, and the second mode of transportation corresponds to at least one of walking, jogging, running, or biking, wherein the selectable option is a first selectable option, the method further comprising: causing the device to display a plurality of selectable options corresponding to the plurality of estimated transportation durations, respectively, wherein the plurality of selectable options comprises at least the first selectable option and a second selectable option corresponding to the second estimated transportation duration; causing the device to display, in association with the first selectable option, an indication of the estimated vehicle transportation duration for the first estimated transportation duration and an indication of the estimated duration for the at least one of walking, jogging, running, or biking for the first estimated transportation duration; and causing the device to display, in association with the second selectable option, an indication of an estimated vehicle transportation duration for the second estimated transportation duration and an indication of the estimated duration for the at least one of walking, jogging, running, or biking for the second estimated transportation duration.

In some embodiments, the selectable option is a first selectable option, the method further comprising causing the device to display a plurality of selectable options corresponding to the plurality of estimated transportation durations, respectively, wherein the plurality of selectable options comprises at least the first selectable option and a second selectable option corresponding to the second estimated transportation duration, and wherein the first estimated transportation duration is greater than the second estimated transportation duration; and causing the device to display a first cost associated with the first selectable option and a second cost associated with the second selectable option, wherein the first cost is less than the second cost. In some embodiments, causing the device to display a prompt related to a willingness to walk at least a threshold amount of time from a drop-off location to the second location; and causing the device to display the selectable option corresponding to the first estimated transportation duration, based at least in part on receiving input, in relation to the prompt, indicating a willingness of the user to walk from a drop-off location to the second location.

In some embodiments, the system may be configured to cause the device to display the selectable option corresponding to the first estimated transportation duration based at least in part on identifying data associated with a profile of the user indicative of a willingness of the user to walk at least a threshold amount of time from a drop-off location to the second location.

In some embodiments, assigning the vehicle to the ride request is performed based at least in part on a profile associated with at least one of the vehicle or a driver of the vehicle indicating a preference for passengers that are willing to walk at least the threshold amount of time.

In some embodiments, the ride request is received by a ride hailing/ride sharing application; and determining, based on a profile of the user, the desired arrival time for the user to arrive at the second location is based at least in part on analyzing an electronic message associated with the profile and received from an application other than the ride hailing/ride sharing application.

In some embodiments, determining the desired arrival time for the user to arrive at the second location comprises receiving explicit input from the user specifying the desired arrival time, in relation to the ride request.

In some embodiments, the user is a first user, the method further comprising: determining that a plurality of users, including the first user, are to be transported from the first location to the second location as part of the ride request, wherein the second location is an airport, and wherein the first user of is to be dropped off at a first airport terminal of the airport, and a second user of the plurality of users is to be dropped off at a second airport terminal of the airport; and selecting the first drop-off location as the first airport terminal based at least in part on comparing flight information for the first user and flight information for the second user For example, if the first user's flight is scheduled to board and take off prior to the second user's flight, the system may determine that the vehicle should drop both passengers off at the first user's terminal, e.g., provided the second user has explicitly or implicitly indicated a willingness to walk, and the walk from the first user's terminal to the second user's terminal is equal to or less than a threshold amount of time. In some embodiments, the first drop-off location may be selected based at least in part on determining that the remaining time before a first user's flight takes off is less than a threshold value (e.g., one hour or 90 minutes). As another example, the system may take into account current security line wait times and/or whether the first user or the second user is subscribed to TSA pre-check, and thus may need less time to navigate to their gate.

In some embodiments, selecting the first estimated transportation time is based at least in part on determining that the first estimated transportation time is less than the other estimated transportation times of the plurality of estimated transportation times.

In some embodiments, the disclosed systems, vehicles, and methods may determine that a driver is traveling to pick up or drop off an item (e.g., takeout food), rather than a passenger. In this case, similar methods may be applied to determine a suitable location for pickup/drop off based on their subsequent destination, as well as desired arrival time based on order details (e.g., pickup time) retrieved from user data. For a food delivery type trip, when multiple orders are being picked up from a source (e.g., restaurant), delivery order and the navigation path ordering may be re-arranged based on the nature of the food (e.g., cold versus hot) and the time delivery promised to the customer and when the particular orders were placed in terms of time sequence order. For example, a delivery driver may temporarily park their car and drop off the package/food at the destination. While the package needs to arrive at a precise destination, the delivery driver may instead park nearby. If the added walking time from the alternate drop off location is less than the reduced driving time, the system may direct the delivery driver to the alternate location, saving time and fuel.

In some embodiments, the disclosed systems, vehicles, and methods may be configured to take into account drop-off locations at or proximate to the second location and/or pickup location at or proximate to the first location. For example, the disclosed systems, vehicles, and methods may receive, from a device, a ride request to transport a user from a first location to a second location, and determine a desired arrival time for the user to arrive at the second location. A plurality of estimated transportation times to transport the one or more users from the first location to the second location may be identified. Such plurality of estimated transportation times may respectively correspond to one or more pickup locations at or within a proximity of the first location (and/or one or more drop-off locations at or within a proximity of the second location), and each of the plurality of estimated transportation durations may be based at least in part on a first mode of transportation associated with the ride request transporting the user from the pickup location (at or within a proximity of the first location) to the destination location (or a drop-off location at or within a proximity of the second location) and enable the user to arrive at the second location by the desired arrival time.

The disclosed systems, vehicles, and methods may be configured to select a first estimated transportation time of the plurality of transportation times which is associated with a first pickup location of the plurality of pickup locations, and which is based at least in part on an estimated transportation duration for the first mode of transportation to transport the user from the pickup location to the second location (or a drop-off location at or proximate to the second location) and an estimated transportation duration for a second mode of transportation (e.g., walking, jogging, biking, etc.) to enable the user to arrive at the first pickup location from the first location. The estimated transportation duration for the second mode of transportation associated with the first estimated transportation duration exceeds an estimated transportation duration for the second mode of transportation associated with a second estimated transportation duration of the plurality of estimated transportation durations. The disclosed systems, vehicles, and methods may, based at least in part on the selecting, cause the device to display an option corresponding to the first estimated transportation time. The disclosed systems, vehicles, and methods may further, based at least in part on receiving selection of the option, cause the device to display an indication of a vehicle assigned to the ride request to pick up the user at the first pickup location associated with the first estimated transportation time and execute a transportation route to transport the user to the second location (or a drop-off location at or proximate to the second location).

For example, in addition to, or in the alternative to, taking into account a desired arrival time and/or a drop-off location that might save time or otherwise be of interest to the user submitting a ride request, the disclosed systems, vehicles, and methods may be configured to take into account a pickup location (e.g., other than, but proximate to, a current location of the user) which may contribute to saved time (e.g., if the user walks a few blocks in a city, it may be beneficial to avoid traffic congestion and/or avoid many turns or one-way roads and/or save fuel) and/or be of interest to the user (e.g., the ride may cost less to incentive the user to acquiesce to the pickup location).

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate functionally similar elements, of which:

FIG. 1 shows illustrative user interfaces for providing transportation options, in accordance with some embodiments of this disclosure.

FIG. 2 shows illustrative user interfaces for providing transportation options, in accordance with some embodiments of this disclosure.

FIG. 3 is a flowchart of a detailed illustrative process for providing transportation options, in accordance with some embodiments of this disclosure.

FIG. 4 is a flowchart of a detailed illustrative process for providing transportation options, in accordance with some embodiments of this disclosure.

FIG. 5 is a diagram of an illustrative system for providing transportation options, in accordance with some embodiments of this disclosure.

FIG. 6 is a flowchart of a detailed illustrative process for providing a transportation option, in accordance with some embodiments of this disclosure.

FIG. 7 shows illustrative data which may be used for providing transportation options, in accordance with some embodiments of this disclosure.

### DETAILED DESCRIPTION

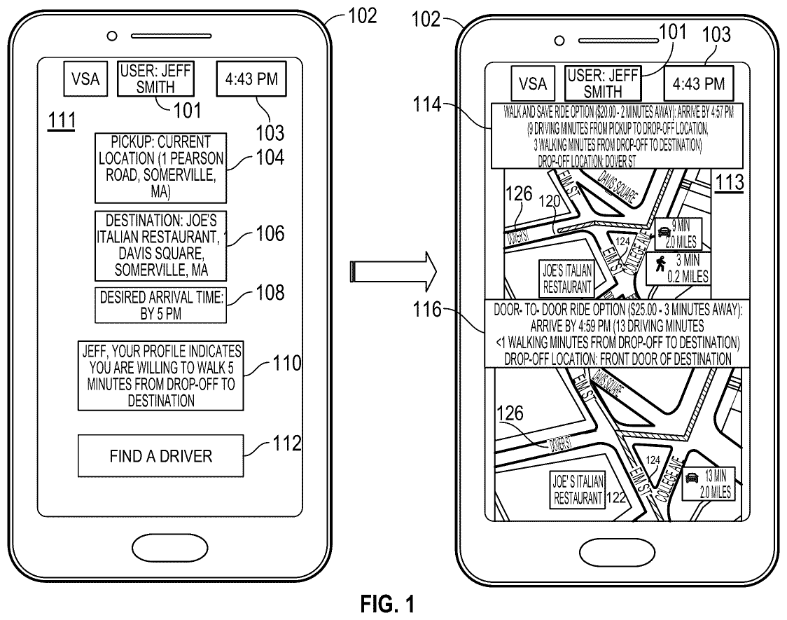

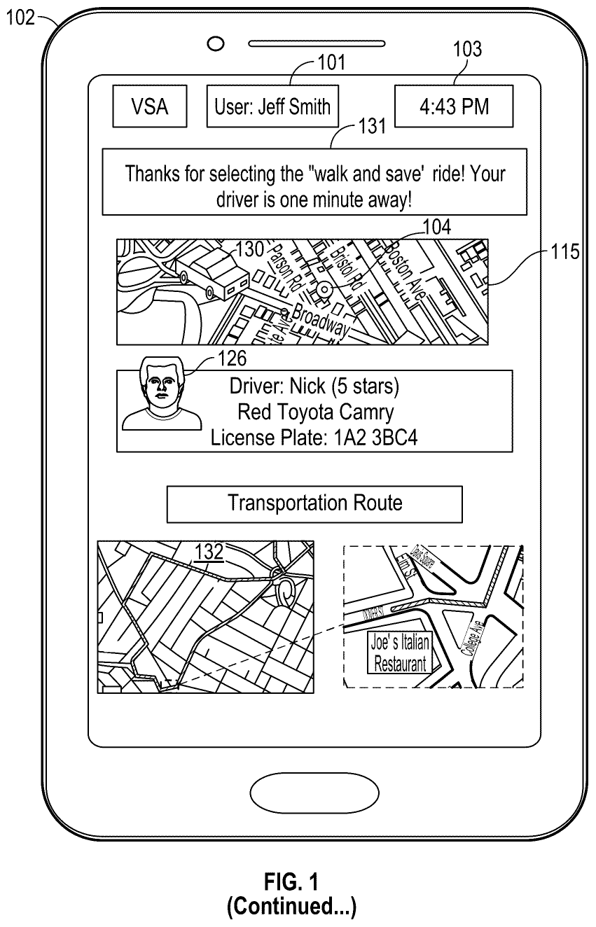

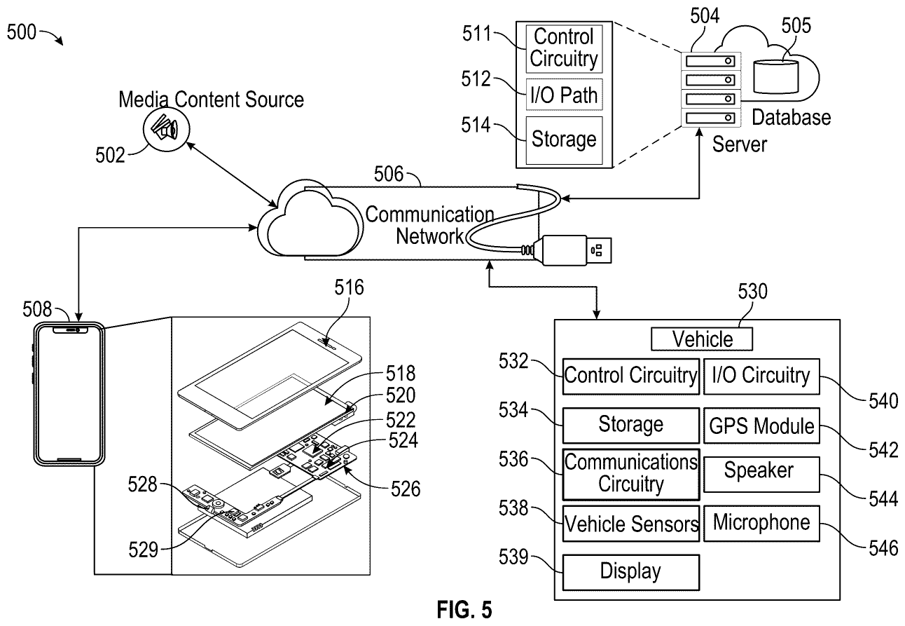

FIG. 1 shows illustrative user interfaces for providing transportation options, in accordance with some embodiments of this disclosure. In some embodiments, a vehicle service application (VSA) may be configured to implement the functionalities (or at least a portion of the functionalities) described herein. The VSA may be, for example, provided as part of a ride sharing (RS) platform, a ride hailing (RH) platform, robotaxi platform, autonomous shuttle/fleet platform, food delivery platform, navigation system platforms, automobile platforms or automobile manufacturers, parcel delivery platform, or any other suitable platform, or any suitable combination thereof. The VSA may be executed at least in part at one or more client devices (e.g., device 102 of FIG. 1, which may correspond to device 508 of FIG. 5) and/or at one or more remote servers and/or databases (e.g., media content source 502 and/or server 506 of FIG. 5) in communication over one or more communication networks with one or more client devices (e.g., a device of the user 101 and/or a device of the driver contracted or employed by the VSA platform), and/or at any other suitable computing device(s) implementing any suitable combination of hardware and software components, or any suitable combination thereof. In some embodiments, the VSA may implement any suitable computer-implemented technique, e.g., executable instructions, algorithms and/or machine learning models, to implement the functionalities described herein.

As shown in FIG. 1, a user 101 may be accessing the VSA by way of device 102. In some embodiments, device 102 may be, for example, a headset; a mobile device such as, for example, a smartphone or tablet; a laptop computer; a personal computer; a desktop computer; a smart watch or wearable device; smart glasses; an extended reality (XR) head-mounted display (HMD); a stereoscopic display; a wearable camera; XR glasses; XR goggles; a near-eye display device; or any other suitable user equipment or device capable of connecting to the Internet or other suitable network; or any suitable combination thereof. While FIG. 1 shows a single user, user 101, requesting a ride of himself or herself, it should be appreciated that user 101 may be requesting the ride on behalf of multiple users. In some embodiments, the VSA may receive an explicit indication of each user to enter the vehicle, or may infer such data based on, e.g., analysis of electronic messages, e.g., multiple airline tickets for an upcoming flight indicated names of various expected passengers in the car.

In some embodiments, the VSA may receive input, by way of user interface 111 of device 102, of a pickup location 104, a destination location 106, a desired arrival time 108, and/or selection of a find a driver option 112, e.g., in connection with a RHRS request, to be transported from the pickup location 104 to the destination location 106 (or another location proximate to the destination location, as discussed in more detail below). In some embodiments, “proximate” may indicate a specific distance for a specific mode of transportation (e.g., within one mile of walking distance) which may be the same or different across different modes of transportation (e.g., a user may be willing to ride an e-bike for a longer period of time than walk). In some embodiments, a drop-off location may be distinguished from a destination location in that a drop-off location may be located at least a certain amount of travel time or travel distance from a destination location (e.g., for walking, at least 2-3 minutes of walking time or 0.2 miles), since it is generally likely or possible that some level of walking (e.g., under 30 seconds or under one minute, such as from the door of a pickup location to the vehicle, and from the vehicle to the door of the destination location) may be required even if the service is “door-to-door” from a pickup location to a destination location.

A ride option provided based on a ride request may include one or more modes of transportation, e.g., by way of a vehicle carrying one or more passengers, walking, running, jogging, and/or any other suitable mode of transportation. A vehicle may be, for example, an automobile, a car, a truck, a train, a tram, a subway, any other suitable form of public transit, a motorcycle, a bus, a scooter, an electric scooter, rollerblades, a segway, a golf cart, a bicycle, an electric bicycle, a boat or other watercraft, an aircraft (e.g., a drone, helicopter, airplane), or any other suitable type of vehicle, or any suitable combination thereof.

Pickup location 104 and destination location 106 may be received as an address, or other identifier of a location, or any suitable portion thereof. Pickup location 104 may be a location that a car (or another vehicle operated by a driver employed by or contracted by the VSA) is to pick up user 101. Destination location 106 may be a location that user 101 ultimately desires to arrive at by desired arrival time 108, whether based on being dropped off by the driver of the car associated with the VSA at such destination location 106, or by navigating to destination location 106 using an alternate mode of transportation, e.g., walking, jogging, running, electric scooter or electric bike, or any other stainable mode of transportation. For example, the VSA may receive, from user 101 via user interface 111, via a microphone, biometric input (e.g., a camera), or other input mechanism, of device 102, text, voice, or biometric input (or any other suitable input) of “1 Pearson Road, Somerville, Massachusetts;” an indication of “current location” in which case the VSA may determine the current location of user 101 using, e.g., a global positioning system (GPS) or any other suitable location system; an indication of a location (e.g., “Home”) stored in relation to a profile of user 101; an indication of a location (e.g., “Joe's Italian Restaurant”) proximate to the location of user 101; based on selection of a point of interest, a hyperlink of a location or address, or other suitable link or icon; and/or via any other suitable format or mechanism.

In some embodiments, the VSA may receive input, by way of an interface of device 102, of a desired arrival time 108. For example, the VSA may receive, from user 101 via the interface of device 102, text or voice input (or via any other suitable input mechanism) of “Joe's Italian Restaurant” and/or “987 11^{th} Ave.” As another example, the VSA may interface with and receive an induction from one or more other applications or profiles (e.g., an email account associated with user 101, a text message application having text data indicating a time to meet at a restaurant, analysis of an electronic message, audio information gleaned from a telephone call made by user 101, based on a restaurant reservations application, other personal information of the user that is shared or identified, and/or any other suitable information or application may be analyzed) to determine the desired arrival time 108. As a non-limiting example, the VSA may determine that an email account of user 101 indicates that the user has made a reservation at 5 PM on the current day for a particular restaurant (e.g., Joe's Italian Restaurant indicated in FIG. 1), and that since a current time (4: 43 PM, indicated at 103) is approaching (e.g., within a threshold amount of time, such as, for example, 30 minutes, of) such 5 PM reservation, the VSA may determine that user 101 would likely desire to arrive by such 5 PM reservation time, in connection with the current ride request. In some embodiments, the desired arrival time 108 may correspond to (e.g., by default) an earliest possible arrival time at the destination, as determined by the VSA based on its driver's availability, alone or in combination with other modes of transportation.

As shown at 110, the VSA may cause display of an indication regarding the willingness of user 101 to walk, e.g., a threshold amount of time (e.g., 5 minutes), from their current location to the pickup location and/or from the location that the ride service is to drop the user off to the destination location. For example, the user 101 may be determined as a willing walker based on their past drop-off locations for previous rides with the VSA and how much walking was involved to navigate from each drop-off location to the destination, based on previously selected “walk and save” rides (discussed in more detail below), based on demographic information (e.g., under a certain age), based on a fitness level (e.g., entered by user 101 to the VSA or another application, or gleaned from other applications or profiles, such as, for example, a fitness app, associated with user 101), based on current weather conditions (e.g., no precipitation, and comfortable temperatures above a threshold, such as, for example, at least 50 degrees Fahrenheit, may indicate that a user may be willing to walk), and/or based on any other suitable information. In some embodiments, 110 may be a selectable or toggleable option, e.g., displaying the question “Are you willing to walk a maximum of 5 minutes to save money on your ride and/or potentially be matched with a driver faster?” In some embodiments, if multiple users are determined to be requesting the ride, each of such user's profile data may be analyzed, individually and in combination, to determine whether such users may be willing to walk, as indicated at 110.

While FIG. 1 shows a “willingness to walk” indication 110, any other mode of transportation, or any suitable combination of modes of transportation, may be indicated at 110 and/or otherwise used for computing an estimated transportation duration from pickup location 104 to destination location 106. For example, indication 110 may relate to a willingness of a user to jog, run, bike, board a train or subway or bus or other public transit, utilize any other suitable vehicle, or any suitable combination thereof, and such willingness may be factored into determining estimated transportation durations for transporting user 101 from pickup location 104 to destination location 106. In some embodiments, indication 110 may relate to user 101 entering another car at a drop-off location, after exiting an initial car that picked up the user at pickup location 104, whether such other car may transport user 101 to their destination location 106 or to a subsequent drop-off location. In some embodiments, such initial car and/or such other car may include only a driver and user 101 in the car, or may include one or more other users in addition to a driver and user 101, e.g., as part of a ride share or carpool type ride.

It should be appreciated that the identification of the information associated with indication 110 is optional. For example, the VSA may assume that any user is willing to walk (or utilize any other suitable mode of transportation) up to, e.g., 3 minutes, or any other suitable threshold time, and factor that in the identification of drop-off locations. Additionally or alternatively, the VSA may identify a drop-off location for any other suitable reason, regardless of whether the user is willing to walk, e.g., based on the drop-off location being more convenient to offload luggage, to avoid a bridge or tunnel, to avoid a construction zone, to avoid police activity, or any other suitable reason, or any suitable combination thereof.

As shown at 112, the VSA may cause display of an option that is selectable to request a ride, based on pickup location 104, destination location 106, desired arrival time 108, and/or indication or indication 110 (e.g., if indication 110 is selected, indicating a willingness to walk or utilize another mode of transport, in addition to the car associated with the VSA that picks up the user at pickup location 104). Based on receiving selection of option 112, the VSA may identify a plurality of estimated transportation durations to transport user 101 from pickup locations 112 to the destination location 106. In some embodiments, at least a portion of the processing to identify the plurality of estimated transportation durations may be performed prior to receiving selection of option 112, e.g., preemptively in anticipation of the request. In some embodiments, to calculate the estimated transportation durations, the VSA may identify one or more navigation routes (e.g., by one or more vehicles, or by a combination of one or more vehicles and another mode of transportation, such as, for example, walking) to travel from the pickup location 104 (or a drop-off location proximate to the entered pickup location) to the destination location 106 (or a location proximate to the entered destination location), based on receiving indications received from a navigation application (e.g., Google Maps or other GPS system), and/or such navigation application may be integrated into the VSA. In some embodiments, the VSA may determine and/or receive data in relation to one or more contextual factors in relation to the one or more navigation routes, e.g., anticipated and/or real-time contextual factors, such as, for example, traffic conditions; roadwork; construction; a parade or other event; a street closure; a flooded road; a traffic light with historically lengthy wait times; police activity; safety and security of the neighborhood, accident or other obstacle along the respective route; the nature of the roads along the route (e.g., one-way roads) including roads proximate to the destination location 106; weather or other environmental conditions; a scheduled or predicted next trip of a driver of the vehicle; and/or any other suitable factors.

Based on the identified navigation route(s) and the contextual factors, the VSA may identify the plurality of estimated transportation durations. This may be based at least in part on identifying one or more vehicles (e.g., autonomously, semi-autonomously, or manually operated on behalf of the VSA) proximate to pickup location 104, and the current status and availability of such one or more vehicles (e.g., whether the vehicle is close to completing a current ride for the ride service prior to the ride request indicated in FIG. 1, how far away the drop-off location for such current ride is from pickup location 104, whether the vehicle is not currently engaged in a ride for the ride service, how close the driver is to the end of their shift, the driver's preference for mixed modes of transportation associated with indication 110, and/or any other suitable factors). In some embodiments, vehicles associated with the VSA may be identified and assigned to a user, such as, for example, user 101, based at least in part on using machine learning techniques, e.g., prior to selection of or when the driver selects option(s) 104, 106, 108, 110, and/or 112, and/or when the driver selects ride option 114 or 116 as shown at user interface 113 of FIG. 1, described in more detail below. For example, the VSA may provide to user 101 a choice between a plurality of ride options and associated drop-off locations.

In the example of FIG. 1, the VSA may identify ride options 114 and 116, associated with estimated transportation durations of 11 minutes and 13 minutes, respectively. Each estimated transportation may correspond to or otherwise be associated with one or more drop-off locations at or near the destination location 106. For example, the estimated transportation duration associated with option 114 may be based on transporting user 101 (via a 9-minute drive from pickup location 104 by way of a car associated with the VSA) to a drop-off location 120 (e.g., an address that is determined to be a two-minute walk from destination location 106). As another example, the estimated transportation duration associated with ride option 116 may be based on transporting user 101 (via a 13-minute drive from pickup location 104 by way of a car associated with the VSA) to a drop-off location 122 (e.g., a front entrance of the restaurant corresponding to destination location 106, requiring less than a minute of walking). In some embodiments, each of ride options 114 and 116 may only be presented to user 101 of device 102 if the respective associated estimated transportation duration enables user 101 to arrive at the second location by the desired arrival time indicated at 108, which is 5 PM in the non-limiting example of FIG. 1.

As shown in FIG. 1, “walk and save” ride option 114 may be selected and presented to user 101, based on the indication 110 of a willingness to walk (or utilize another or an additional mode of transportation) being identified, and/or an option associated with indication 110 being selected or activated, when a ride is requested. Such option 114 may, as compared to ride option 116, be estimated to enable user 101 to arrive at destination 106 earlier than each of ride option 116, albeit being estimated to require more walking (e.g., 3 minutes, within the threshold indicated at 110) than option 116 (e.g., less than one minute of walking). In some embodiments, ride option 114 may be estimated to take longer than ride option 116 with respect to the user 101 arriving at their destination, but user 101 may be incentivized (e.g., with a lower cost of the ride and/or points or other rewards for their profile on the VSA) to choose ride option 114, which may contribute to a more efficient navigation system, e.g., the drop-off location for ride option 114 may be more beneficial for the driver in terms of a scheduled or predicted subsequent pickup location for a new passenger, as compared to the drop-off location for ride option 116.

In some embodiments, as shown in FIG. 1, ride option 114 may cost less money than ride option 116, and/or allow the user 101 to be picked up by a driver sooner than ride option 116. For example, the VSA may desire to incentivize user 101 to select ride option 114 based on a time savings (and/or fuel savings) that ride option 114 provides over ride option 116, and/or drop-off location 120 may be more convenient for the driver of the vehicle's scheduled or predicted next ride, e.g., subsequent to dropping off user 101, as compared to drop-off location 122. For example, such time savings may be based on, for example, drop-off location 120 allowing the driver to avoid the aforementioned anticipated real-time traffic conditions. For example, as shown in FIG. 1, more traffic is present on the route traveling down Elm Street (indicated at 124) towards the front entrance of Joe's Italian restaurant corresponding to drop-off location 122, as opposed to the drop-off location 120 on Dover Street (indicated at 126) which at least partially may avoid such traffic), roadwork, construction, a parade or other event, street closure, a flooded road, a traffic light with historically lengthy wait times, police activity, accident, or other obstacle along the respective route, and/or time-consuming roads (e.g., one-way or limited access roads). On the other hand, navigating to drop-off location 122 associated with ride option 116 might require the driver to navigate their vehicle through such obstacles, traffic, or inconveniences, in order to drop user 101 off at drop-off location 122 (e.g., a front door of the destination location 106). In some embodiments, similar considerations may additionally or alternatively be taken into account for suggesting a pickup location (e.g., proximate to, but distinct from, the user's current location) to user 101, e.g., if the VSA determines that picking up the user at a different nearby location could potentially save time, if the user is willing to utilize another mode of transportation to navigate from their current location to the pickup location.

In some embodiments, upon receiving selection of ride option 114 or 116, the VSA may present user interface 115, and/or one or more portions thereof, to user 101 and/or driver 126 (e.g., employed by or contracting with an entity providing or otherwise associated with the VSA). For example, the VSA may cause driver 126 of vehicle 130 to be assigned to the ride request of user 101. User interface 115 may provide an indication or graphical element representing driver 126, vehicle 130, pickup location 104, and transportation route 132 (including drop-off location 120), and an indication of destination 106. For example, based on receiving selection of ride option 114, a driver-facing portion of the VSA (and/or a passenger-facing portion of the VSA) may be configured to provide a user interface indication to the driver 126 and/or user 101 to indicate vehicle 130 being driven by driver 126 is assigned to pick up user 101 at pickup location 104. The driver may be accessing the driver-facing portion of the VSA via their smartphone and/or via a device or infotainment system of vehicle 130. In some embodiments, user interface 115 may include a confirmation 131 of the selection of ride option 114, e.g., associated with the estimated transportation duration of 11 minutes shown at user interface 113.

User interface 115 may indicate the transportation route 132 to be executed to transport user 101 from pickup location 104 to drop-off location 120, according to the estimated transportation duration associated with ride option 114. In some embodiments, the vehicle assigned to ride option 114 may be assigned to either ride option 114 or 116, or the driver may indicate a preference for certain types of rides, e.g., “walk and save” or “door-to-door,” and only be matched with or assigned to the ride that matches their preference. In the example of FIG. 1, navigating to a drop-off/pickup spot around the corner from the destination may save the driver more time than it costs the passenger, e.g., due to current traffic conditions.

In some embodiments, ride options may additionally or alternatively be presented dynamically while user 101 is in a vehicle providing the ride service. For example, if an updated traffic condition or other obstacle is detected along a route while user 101 is in the vehicle, the VSA may dynamically determine one or more new recommended drop-off locations that might save time and/or a cost of the ride, albeit with more walking (e.g., assuming the user 101 is willing to walk). The one or more new drop-off location may be identified based on being estimated to enable the user to arrive by desired arrival time 108. VSA may prompt user 101 and/or the driver with such new recommended drop-off location, and may update the ride with the new drop-off location automatically or based on user and/or driver confirmation. For example, the VSA may automatically change the drop-off location during the ride, e.g., to a new drop-off location that is estimated to enable the user to arrive at the destination by desired arrival time 108, if the current drop-off location (e.g., associated with selected ride option 114) is no longer estimated to allow the user to arrive at the destination by desired arrival time 108.

In some embodiments, ride option 114 may not be provided, or may be provided with an indication that the vehicle of the VSA will not be dropping the user off at the entrance of the destination location 106, if the VSA determines (e.g., based on user input, analysis of sensor data and/or analysis of electronic messages) that a single passenger in the vehicle is below a certain age (e.g., 13) or that all passengers in the vehicle of the VSA are expected to be below such age. For example, for safety reasons and/or the peace of mind of a parent, it may be desirable for younger children, if riding without a parent or chaperone in the vehicle, to be dropped off as close as possible to the destination, even if walking or using another mode of transportation from a drop-off proximate to the destination location might save time for the passengers and/or driver.

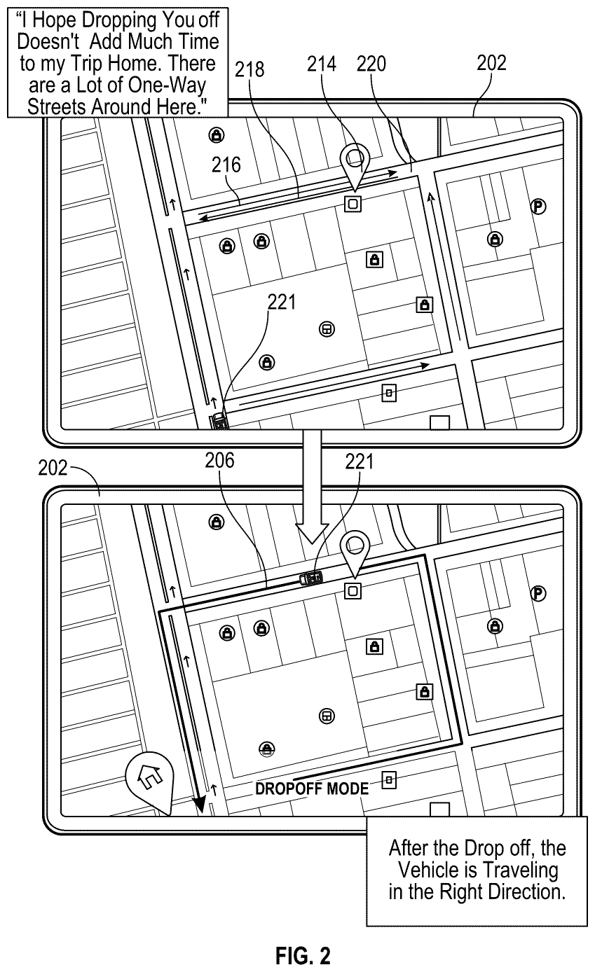

FIG. 2 shows illustrative user interfaces for providing transportation options, in accordance with some embodiments of this disclosure. As shown in FIG. 2, the VSA may identify one or more drop-off locations 214, and/or one or more routes to drop-off location, based at least in part on one or more aforementioned contextual factors and/or a user's willingness to walk (or utilize another mode of transportation, e.g., electric scooter, other than a car ride by a driver for the VSA platform) from the drop-off location to the destination (and/or from the requested pickup location to a new pickup location). For example, the contextual factors may include a driver's next scheduled (or predicted) ride. In some embodiments, the VSA may determine that a driver has provided input on their device, e.g., executing a driver-facing portion of the VSA, indicating a selection of an option to accept a next ride while the current user is still in the vehicle and being transported to drop-off location, and the VSA may determine the pickup location of the next scheduled ride on this basis. As another example, the VSA may determine that the next ride of the driver was previously scheduled, e.g., a pickup booked in advance, and may tailor a current drop-off location to put the driver in a position to more easily navigate to such next ride pickup location. As another example, the VSA may determine, e.g., based on historical data of ride service rides in the area, that a next ride is likely to be requested from a certain nearby location (e.g., an airport), and thus it may be advantageous to select a navigation route and/or drop-off location that would allow the driver to be traveling in a direction towards the predicted ride at the airport upon dropping off the current passenger.

For example, the VSA may determine that is preferable for vehicle 221 to execute a navigation route that includes traveling direction 218 down road 220, as opposed to traveling direction 216 down road 220, at least in part because traveling direction 218 down road 220 would set the driver up better for their next scheduled (or predicted) ride, e.g., would allow the vehicle to continue driving straight on the same road towards the next pickup location or otherwise arrive at their next pickup location faster than if an alternative route including travelling direction 216 down road 220 (and/or other alternative routes) were taken. This determination may be made even if the user, upon being dropped off, may have to walk (or utilize another mode of transportation) for a certain distance (e.g., corresponding to a 5 minute walk) that exceeds the amount of walking time (or other mode of transportation time) had an alternative route been pursued, e.g., provided the user would still be able to arrive at the desired arrival time, when factoring in the 5 minute walk. The determination may be based at least in part on traffic data, map data (e.g., one-way streets), road closures, car accidents, weather or other environment factors, GPS data, and/or any other suitable contextual factors. Such features, by considering future navigation destinations (e.g., a subsequent ride for a user to be picked up by the driver of the vehicle, or a subsequent drop-off of a user that is currently in vehicle and is to be dropped off at a different location) may provide for a more efficient transportation platform, and allow more efficient utilization of resources (e.g., fuel) and over time may save wear-and-tear on the vehicle, without significantly inconveniencing the user. That is, the VSA may provide a navigation system that considers the desired passenger arrival time as well as the driver's subsequent destinations when selecting a drop-off location.

In some embodiments, the VSA may determine that a ride request is associated with transporting multiple passengers to the same destination or different destinations. For example, the VSA may determine that multiple passengers are in the vehicle based on multiple destinations being specified in the ride request, based on an explicit input indicating that multiple passengers will be getting in the vehicle, and/or based on a ride type (e.g., a request for an SUV may indicate it is likely that multiple users are to be getting in the vehicle for the ride). As another example, vehicle sensors, e.g., seat sensors, may determine the presence of multiple users in the vehicle, or any other suitable sensors (e.g., a microphone or a camera in the vehicle) may indicate that multiple users are in the vehicle. For example, the VSA may use vehicle sensors to detect, in real-time, passengers getting in or getting out of the vehicle, and may automatically adjust one or more of the transportation routes to be executed by the vehicle. As an example, a desired arrival time and drop-off location for a user that is determined to have exited the vehicle may be disregarded, and estimated transportation durations, and selected transportation routes, for the remaining user(s) may be recalculated using the factors described herein, without reference to the information of the exited passenger. As another example, a desired arrival time and drop-off location for a user (and their willingness to utilize another mode of transportation other than the VSA vehicle) that is determined to have entered the vehicle may be identified, and estimated transportation durations, and selected transportation routes, for the remaining user(s) may be recalculated using the factors described herein, e.g., based on an aggregation of the current passengers information. For example, if the new passenger specifies a same or similar destination as another user having already been present in the vehicle and having indicated a willingness to walk, but such new passenger is not willing to walk, a drop-off location for such users may be identified that reduces walking time for the new passenger but still allows the existing passenger to walk. As another example, if a passenger is determined to enter or exit the vehicle, an order of drop-off locations may be rearranged, based on a comparison of the destination locations, willingness to utilize other modes of transportation, desired arrival times, and/or contextual factors of projected transportation routes for the current passengers.

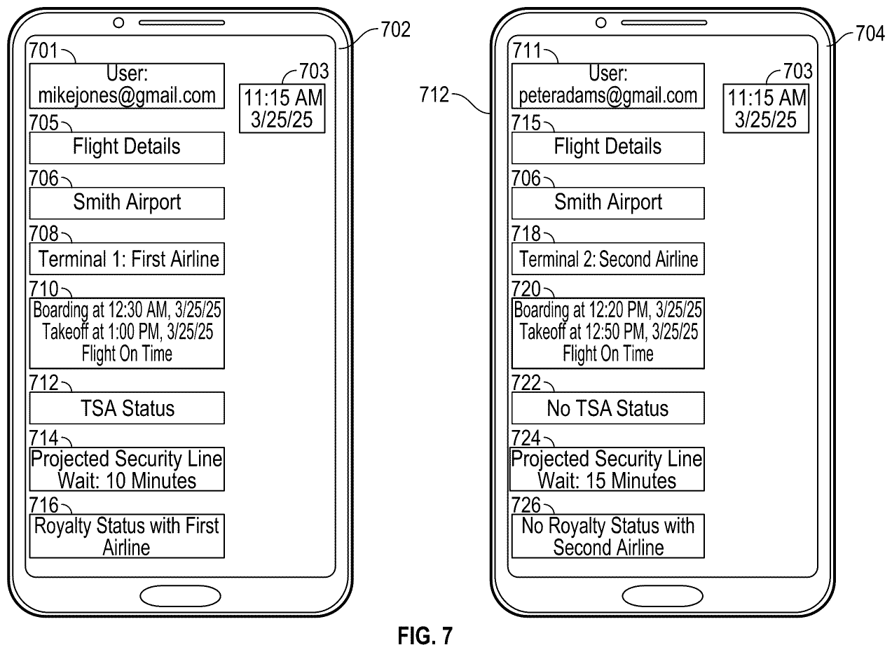

For instance, for a ride share scenario, in which multiple passengers are going to the same destination (e.g., an airport), the VSA may arrange or reorder the drop off order or navigation order for the passengers based on, for example, their terminal and time left for their flight departure (e.g., identified via a search of the users emails or text messages or other application, and/or based on the VSA being in communication with respective applications associated with different airlines). Additionally or alternatively, the VSA may consider other parameters such as, for example, wait time at the security checkline, whether the passenger(s) have TSA-Precheck access, boarding time based on their seat/airline royalty status, and/or any other suitable parameters, as shown and described below in relation to FIG. 7. One or more of such parameters can be ingested to the navigation system associated with the VSA to facilitate computing the order of drop-off and/or pickup, e.g., which passenger can be dropped off earlier and how the navigation/drop off points will be computed. While an airport is described above, the VSA may arrange drop-off locations for passengers at any suitable type of location, e.g., a hospital with multiple doors (one for emergency situations and one for non-emergency situations), a campus with multiple entry points, a sports stadium or entertainment venue with multiple entry points, or any other suitable type of location.

In some embodiments, vehicle 221 (which may correspond to the vehicle 130 indicated in FIG. 1) may pick up multiple passengers at a pickup location, and such multiple passengers may have different drop-off locations and/or different destination locations. For example, the VSA may determine that a driver (or autonomous vehicle) should be instructed to execute a transportation route that includes traveling direction 218 down road 220 after dropping a first user of the multiple users off at drop-off location 214, based on determining that traveling in such direction 218 after the drop off is estimated to allow the vehicle to arrive at a second user of the multiple user's drop-off location or destination location relatively faster than if an alternate route was taken. For example, the VSA may determine which side of the street to drop the first user off at, e.g., an east side or west side, to reduce the time to the second user's drop off spot. In some embodiments, if a destination is modified or added or removed from an on-going ride being provided in association with the VSA, the VSA may dynamically compute updated drop-off locations for one or more of the destinations, based on the modification, addition, or removal of a destination.

In some embodiments, to help improve the efficiency of drop-off and pickup navigation the VSA may, when a driver requests a multi-stop navigation route, identify whether it is a drop off/pickup trip using contextual information (e.g., VSA activity in the app shown in FIG. 1) and available user data (e.g., emails, messaging). If it is a drop-off/pickup trip, the VSA may determine the passenger's desired arrival time based on available user data (e.g., dinner reservations, movie start time). The VSA may determine alternate drop off locations that enable a passenger to reach their destination by the desired arrival time. Optionally, the VSA may limit the available drop-off/pickup locations based on how long or far the passenger is willing to walk or utilize another mode of transportation. The VSA may determine travel times from alternate drop-off locations to a second drop-off location or destination location of the multi-stop navigation route, and select the first drop-off location proximate to the first destination location to minimize travel time for the driver while ensuring the passenger reaches their drop-off destination in time and walks (or utilizes another mode of transportation) for a sub-threshold time and/or distance (e.g., 5 minutes and/or 0.3 miles, or any other suitable threshold(s), which may vary for different modes of transportation). Optionally, the VSA may select the first and/or second and/or subsequent drop-off location with minimal overall travel time between the driver and dropped off passenger, or one that balances either the driver or passenger's travel times. In some embodiments, the VSA may determine and/or update a trip type (e.g., drop-off, pickup) based on navigation destination, user data, and car sensors, and may modify a navigation destination based on predicted future destination, desired passenger arrival time, and/or driver/passenger preferences.

In some embodiments, the techniques described herein may help improve transportation apps by reducing driving time and reducing fuel usage for drivers and/or vehicles when picking up or dropping off. For RHRS apps, the techniques described herein may enable a desired arrival time to be set, and/or provide discounted rides if the user is willing to utilize multiple modes of transportation and be dropped off at a drop-off location proximate to the destination location.

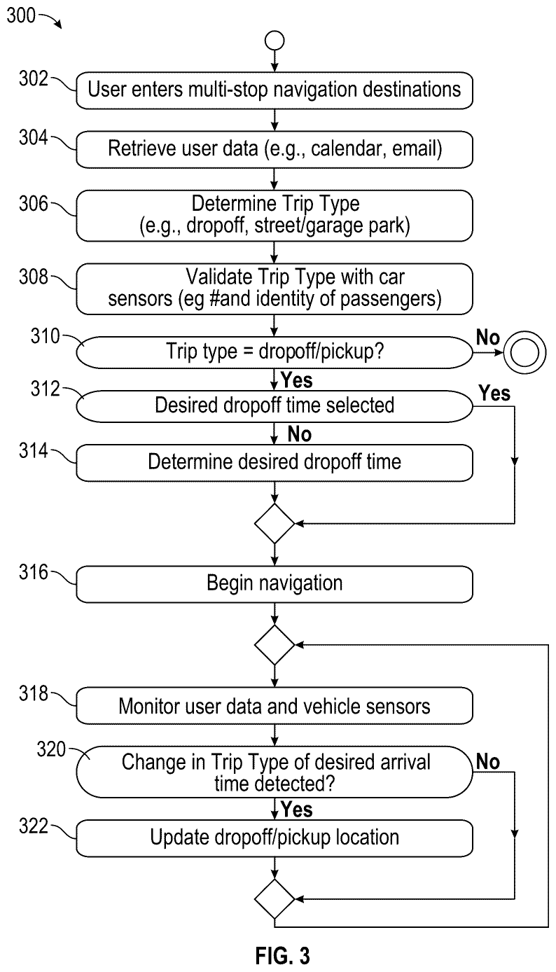

FIG. 3 is a flowchart of a detailed illustrative process 300 for providing transportation options, in accordance with some embodiments of this disclosure. In various embodiments, the individual steps of process 300 may be implemented by one or more components of the devices, methods, and systems of FIGS. 1, 2, and 4-7 and may be performed in combination with any of the other processes and aspects described herein. Although the present disclosure may describe certain steps of process 300 (and of other processes described herein) as being implemented by certain components of the devices, methods, and systems of FIGS. 1, 2, and 4-7, this is for purposes of illustration only, and it should be understood that other components of the devices, methods, and systems of FIGS. 1, 2, and 4-7 may implement those steps instead.

At 302, the VSA may receive input from one or more users requesting a multi-stop navigation destination ride. At 304, the VSA may receive user data (e.g., calendar data and/or email data). At 306, the VSA may determine that a vehicle is driving to a location with the intent of dropping off or picking up a passenger, rather than driving to a location for the purpose of parking, e.g., pickup/drop-off may be a trip type, distinct from other trip types such as, for example, park at destination. In some embodiments, the driver may manually enter in a multi-stop destination and optionally indicate that they are picking up/dropping off. At shown at 308, if the driver has not manually provided multi-stop destinations or trip type, such information may be available via user data such as, for example, based on sensor data, email messages, calendar events, or messaging (e.g., SMS, WhatsApp), as indicated at 304. For example, a user who has purchased movie tickets may have received an email or text message indicating a showtime, movie theater location, number of tickets purchased, and/or other suitable data. Such information may be compared to navigation destination, departure time, and number and identity of passengers to enable accurate estimation of trip type.

In some embodiments, sensor and user data may be used to infer the trip type, as indicated at 308. For example, a vehicle may be estimated to arrive after an identified event has ended (indicating that the trip type is a pickup). As another example, the driver or a passenger may have purchased 2 tickets to an event, and the car may contain 3 passengers, indicating that the trip type is a drop off. As another example, the driver or a passenger may have purchased 2 tickets to an event, the car contains 3 passengers, the passenger's name is mentioned in the ticket confirmation, and the driver's is not, indicating that the trip type is a drop off. As another example, the driver may have placed a pickup food order (or may have been assigned to pick up the food order and deliver it to ac customer) and they may be navigating to the restaurant with an estimated arrival time within a threshold duration of the order's pickup time, indicating a trip type of pickup.

If the VSA determines that the trip type is a pickup and/or drop off, processing may proceed to 312. At 312, the VSA may determine whether a desired drop off time has been selected. If so, processing may proceed to 314; otherwise, processing may proceed to 316. For example, at 312, the VSA may determine that a passenger has manually provided input to indicate their desired drop off/pickup time in a navigation or RHRS app, or the system may determine this time based on available user data. For example, a movie ticket confirmation email may include movie start time and duration, which may inform desired drop off/pickup time. Such confirmation may also include the number of purchased tickets, which may inform the determination of trip type. For example, if a passenger has received email confirmation for a single movie ticket, the system may increase its confidence in trip type=drop off.

At 316, when the VSA begins navigation, the VSA may, at 318, identify the number and/or identity of passengers with data from vehicle sensors such as in-cabin cameras or pressure sensors in car seats. For example, vehicle sensors (e.g., a camera mounted in the car) may be used to identify the number and/or identity of passengers. If device-to-device communication of passenger profile information is possible based on user data sharing settings, the system may retrieve user identity data directly from passenger devices. If device-to-device communication of passenger phone sensor data is available, the system may employ any suitable technique to determine user identity from smartphone sensor activity.

If the driver or passengers have not entered a multi-stop destination, the VSA may retrieve navigation or location history to identify patterns that coincide with the current destination. For example, a driver navigating to a movie theater may be picking up, dropping off, or parking there. For example, if a driver is navigating to a movie theater 2 hours after navigating to the same movie theater with trip type=drop off, the VSA may conclude that the current trip type=pickup. In some embodiments relevant user information such as movie start time, movie length (e.g., in isolation or with buffer time for commercial, trailers, etc.), and/or movie end time retrieved from a confirmation email may inform the Trip Type determination.

In some embodiments, in navigation or rideshare settings, a passenger may indicate a preferred and/or maximum walking time. Alternatively, a passenger may select a preferred and/or maximum walking time during navigation. If the VSA is unable to retrieve a passenger's preferred walking time, it may infer this value based on the passenger's navigation history (e.g., someone who walks at least one hour per day may be likely to prefer and tolerate a longer walk). If the VSA is unable to retrieve a passenger's maximum walking time, it may infer this value based on demographic information (e.g., a 20-year-old may be associated with a higher maximum walking time than an 80-year-old). The VSA may attempt to identify passengers with physical impairments based on user profile data, message history, or using vehicle sensors to identify assistive devices (e.g., canes, walkers) in the vehicle or objects indicative or a willingness to walk (e.g., the passengers wearing running shoes or holding a basketball or football). For example, such objects may be identified based on analyzing one or more images captured by a camera of device 102, a device of the vehicle associated with the VSA platform, and/or a device of the driver of the vehicle, where such analysis may be performed using any suitable image recognition technique. If the assistive devices are identified, the VSA may cause navigation directly to the desired destination rather than selecting an alternate drop off location. On the other hand, if objects indicative or a willingness to walk are detected, the VSA may cause navigation to (or suggest a recommend route based on) an alternate drop off location.

In some embodiments, at 320 and/or 322, the VSA may consider car sensor data when determining whether to update trip. For example, if the VSA detects that a passenger has exited or entered the vehicle, it may repeat the determination of trip type and optimal drop off/pickup location based on updated passenger data. For example, the system may use car sensors to determine when a new passenger has been picked up, which may influence chosen trip type. For example, if the system is aware that a user has purchased 2 movie tickets and is driving with 1 passenger, it may conclude that trip type=park at destination. If the VSA then detects that another passenger has entered the vehicle, it may conclude that the new passenger is the second moviegoer and modify the trip type to drop off.

In some embodiments, the VSA may continue to monitor user data during navigation. For example, if there is a single passenger in the vehicle and they receive an email confirmation for 2 purchased movie tickets, the system may determine the driver is likely to be the second movie attendee and increase its confidence in trip type=park at destination (e.g., in a social outing involving the driver and passenger, case where the driver is not providing a RHRS service or other transportation service). As an example, if the passenger receives a message saying, “Can't wait to see that movie with you!” from a contact, or such language is detected, e.g., during a phone call taking place in the vehicle, the system may determine that trip type=drop off.

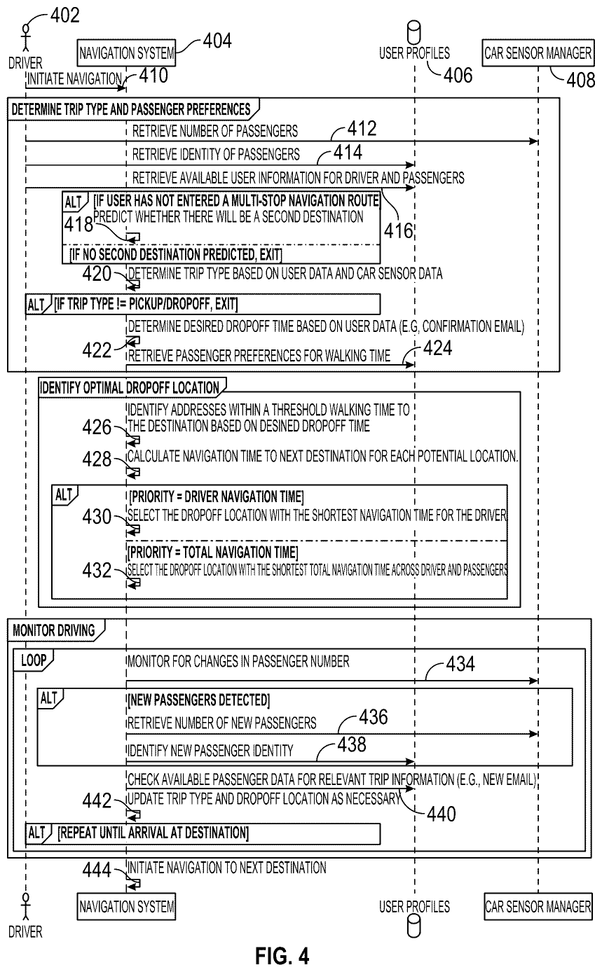

FIG. 4 is a flowchart of a detailed illustrative process 400 for providing transportation options, in accordance with some embodiments of this disclosure. In various embodiments, the individual steps of process 400 may be implemented by one or more components of the devices, methods, and systems of FIGS. 1-3 and 5-7 and may be performed in combination with any of the other processes and aspects described herein. Although the present disclosure may describe certain steps of process 400 (and of other processes described herein) as being implemented by certain components of the devices, methods, and systems of FIGS. 1-3 and 5-7, this is for purposes of illustration only, and it should be understood that other components of the devices, methods, and systems of FIGS. 1-3 and 5-7 may implement those steps instead.

At 410, the driver 402 (and/or a requesting passenger) may initiate navigation. For example, the driver 402 may provide input, to navigation system 404 (e.g., which may be part of or in communication with the VSA) to accept a ride request and/or input requesting navigation instructions to a drop-off location or destination location.

At 412, navigation system 404 may retrieve a number of passengers from car sensor manager 408 (e.g., which may be part of or in communication with the VSA), and at 414, navigation system 404 may retrieve an identify of passengers from user profiles data structure 406 e.g., as discussed in relation to FIG. 3. At 416, navigation system 404 may retrieve available user information for the driver and/or passenger(s) e.g., as discussed in relation to FIG. 3. At 418, the VSA may predict whether there will be a second destination, e.g., amongst multiple passengers currently in, or to enter in the future, the vehicle associated with the VSA. At 420, the VSA may determine a trip type based on user data and car sensor data, e.g., as discussed in relation to FIG. 3. For example, 418 may be performed if a user has not entered a multi-stop navigation route. At 420, the VSA may determine the trip type based on user data and car sensor data 420. At 422, the VSA may, if the trip type is a pickup and/or drop off, determine a desired drop off time, e.g., based on explicit user input entering a desired arrival time, or based on contextual data such as, for example, a confirmation email scanned in the user's email account.

At 424, the VSA may, if the trip type is a pickup and/or drop off, retrieve passenger preferences for an alternate mode of transportation, e.g., walking, such as, for example, by communicating with user profiles data structure 406. For example, the VSA may provide an option for a passenger to indicate the preference of walking time or distance at the time of requesting a ride. When it is an input at the request, the VSA may optimize its dispatching and notify potential drivers if a passenger is more willing to walk. For instance, with the passenger's input at request, the VSA may offer drivers, before they accept the request, an estimate of reduced or increased time before dropping off the passenger at the desired destination. The drivers who intend to do multi-stop pick-ups can assess and benefit from a better possibility or flexibility in dropping off, which may make the subsequent pick-ups more efficient.

In some embodiments, the VSA may determine or modify a user's preferred and maximum walking time based on contextual or environmental factors such as weather (e.g., clear day vs. raining), current temperature, and/or apparent (e.g., feels like”) temperature (e.g., 70°vs 100°). If a user enters their preferred and maximum walking time on a day with negative weather patterns, the system may prompt the user to adjust their selection on a day with preferred weather. In some embodiments, rather than store single preferred and maximum walking time values, the system may store multiple time values associated with different weather conditions and retrieve the appropriate values based on current weather conditions.

In some embodiments, to identify an optimal drop off/pickup location, the VSA may perform one or more of 426-432, and/or any other suitable steps. For example, at 426, the VSA may identify addresses within a threshold walking time (or other mode of alternate transportation than the vehicle associated with the VSA) to the destination based on desired arrival at the destination location, and at 428, calculate a navigation time to a next destination for each potential location. For example, once the VSA has identified multi-stop navigation destinations, passenger walking preferences, and desired drop off time, the VSA may construct a radius around the destination in which estimated walking duration is below a passenger's maximum walking time. The system may construct a list of addresses within this radius and determine their walking duration to the destination. In some embodiments, rather than examine every possible address, the system may select a subset of addresses within the given radius (e.g., every other address, 1 address every 20 meters). The VSA may identify addresses within a threshold of a passenger's preferred walking time and weigh those addresses more heavily when deciding drop-off/pickup location.

In the case of multiple locations possibly detected for drop-off, other conditions, such as, for example, traffic may be taken into account. For instance, the VSA may estimate that, at a current time, driving a block closer to a destination may take 10 minutes while walking from the current location only adds 3 minutes. This may be helpful especially when the passenger has limited time (e.g., below a threshold amount of time) to spare prior to a desired time of arrival, e.g., catching the next train, or desiring to arrive on time to a restaurant reservation or other appointment. In other words, the priority of preferred walking time may become lower even if adding 3 minutes exceeds the threshold, or the threshold can be dynamically adjusted considering the current and updated conditions. This can be predicted and notified to the driver and passenger before approaching a traffic jammed area, e.g., in rush hours, and can be mutually beneficial to both the driver and the passenger.

In some embodiments, the VSA may prioritize certain features over user preferences when selecting a drop off/pickup location. For example, depending on the context, a driver or passenger may indicate they wish to optimize for the driver's multi-stop navigation duration (e.g., there and back). In the case where the car has multiple passengers and they are not all getting out at the current destination, the VSA may prioritize the total navigation time across all passengers. The system may instead prioritize dropping passengers off so that their walking duration to the destination is closest to their preferred walking duration. Such priorities may be combined and ranked to accommodate multiple priorities. For example, if users have indicated equal priority for driver navigation duration and passenger preferred walking time, the system may select a drop off/pickup location with an optimal tradeoff between these two factors, rather than prioritizing either one in isolation. With potential drop off/pickup locations identified and user priorities considered, the system may select the optimal drop off/pickup location and begin navigation to that destination.

In some embodiments, the VSA may consider the number of passengers in the vehicle when considering drop off/pickup locations. For example, if a driver and/or vehicle (e.g., an autonomous vehicle) has no other passengers in the car and dropping off a user at the precise location adds 20 seconds, this duration may be below a threshold and the system may direct the driver to the precise drop off location. If the driver has 3 other passengers in the car, then 20 extra seconds increases to 80, which may be above a total time threshold. In some embodiments, rather than considering the driver and passenger equally, the system may weigh the driver's or passenger's time more heavily. In some embodiments, the system may consider whether a rideshare driver has the next stop selected (e.g., their next passenger queued up in Uber) and weigh the driver's time more heavily if they are en route to a new passenger.

In some embodiments, if the priority is the driver's navigation time, the VSA may (at 430) select the drop-off location with the shortest navigation time for the driver, On the other hand, if, at 432, the VSA determine that the total navigation time is to be prioritized, the VSA may select the drop-off location with the shortest total navigation time across driver and passengers.

At 434, the VSA may communicate with car sensor manager 408, to monitor for changes in the number of passengers in the vehicle. If new passengers are detected, the VSA may retrieve the new number of passengers, based on communicating with car sensor manager 408, and may determine the identity of the new passengers, at 438. At 440, the VSA may check available passenger data for relevant trip information, e.g., a new email, and may, if needed, update the trip type at 442. In some embodiments, the VSA may monitor available vehicle sensor and user data to inform trip type and navigation preferences. For example, the VSA may perform employ speech-to-text (STT) and natural language understanding (NLU) methods to transcribe detected passenger conversation, identify topics being discussed and their properties, and determine user sentiment. For example, if multiple passengers are excitedly discussing a movie playing at the destination but the driver is not, the system may determine trip type=drop off. Similarly, a passenger saying “Thanks for agreeing to drop me off” may inform the system that trip type=drop off.

In some embodiments, 434-442 may be repeated until a drop-off location or destination is reached. At 444, the VSA may initiate navigation to the next destination, e.g., for a subsequent ride.

In some embodiments, the VSA may determine that a driver is traveling to pick up or drop off an item (e.g., takeout food), rather than a passenger. In this case, similar methods to those described herein may be applied to determine an optimal location for pickup/drop off based on their subsequent destination, as well as desired arrival time based on order details (e.g., pickup time) retrieved from user data. For example, the techniques described in FIGS. 1-7 may be employed to determine whether the delivery driver is willing to walk (or utilize another mode of transport) from a parking location to a destination at which the food is to be dropped off (e.g., the front door of the customer ordering the food), such as if doing so may enable the delivery driver to drop off a food order more quickly than if the driver navigated all the way to the customer's door by way of their initial vehicle. Additionally or alternatively, the VSA may take into account whether a particular drop-off location may be beneficial, e.g., to set the delivery driver up for navigating to a subsequent delivery drop-off location more quickly than if the delivery driver navigated all the way to a customer's front door or residence, such as, for example, if the delivery driver is in a congested city where certain streets at which food is to be dropped off may be a one-way street and/or may have heavy traffic. For a food delivery type trip, when multiple orders are being picked up from a source (restaurant), delivery order and the navigation path ordering may be re-arranged based on the nature of the food (cold versus hot) and the time promised to the customer and when the particular orders were placed in terms of time sequence order.

In some embodiments, the system may apply the methods described above to improve the efficiency of food or package drop off routes. In this case, dropping off refers to a delivery driver temporarily parking their car and dropping off the package/food at the destination. When the package is to arrive at a precise destination, the delivery driver may instead park nearby. If the added walking time from the alternate drop off location is less than the reduced driving time, the system may direct the delivery driver to the alternate location, saving time and fuel.

FIG. 5 is a diagram of an illustrative system 500 for providing transportation options, in accordance with some embodiments of this disclosure. User equipment device 508 may correspond to, for example, device 102 of FIG. 1, device 202 of FIG. 2, e.g., a mobile device, infotainment device, and/or other device of an occupant or operator of a vehicle, and/or a mobile device or other device of a passenger or future passenger of the vehicle. In some embodiments, user equipment device 508 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment device 508 and/or provide navigation instructions to a pickup location, drop-off location, and/or destination location, or any other suitable location(s). In some embodiments, device 600 comprises a rechargeable battery that is configured to provide power to the components of the device.

User equipment device 508 may be coupled to communication network 506. Communication network 506 may be one or more networks including the Internet, a mobile phone network, mobile voice or data network (e.g., a 5G, 4G, or LTE network), cable network, public switched telephone network, short-range communication network, or other types of communication network or combinations of communication networks. Paths (e.g., depicted as arrows connecting the respective devices to the communication network 506) may separately or together include one or more communications paths, such as a satellite path, a fiber-optic path, a cable path, a path that supports Internet communications (e.g., IPTV), satellite communications (e.g., GPS), free-space connections (e.g., for broadcast or other wireless signals), or any other suitable wired or wireless communications path or combination of such paths. Communications with the client devices may be provided by one or more of these communications paths but are shown as a single path in FIG. 5 to avoid overcomplicating the drawing. Any suitable number of additional user equipment devices may be employed (e.g., a user device of an occupant or operator of the vehicle).

Although communications paths are not drawn between user equipment devices, these devices may communicate directly with each other via communications paths as well as other short-range, point-to-point communications paths, such as for example, USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 506.

System 500 may comprise media content source 502 and server 504. In some embodiments, media content source 502 may correspond to server 504 and/or media content source 502 may correspond to server 504 may be under the control of or otherwise associated with a media content provider. In addition, there may be more than one of each of media content source 502 and server 504, but only one of each is shown in FIG. 5 to avoid overcomplicating the drawing. If desired, media content source 502 and server 504 may be integrated as one source device. In some embodiments, the VSA may be executed at one or more of control circuitry 511 of server 504, control circuitry 526 of user equipment device 508, and/or control circuitry 532 of vehicle 530. In some embodiments, audio and/or video and/or audiovisual content, e.g., map information or GPS information, may be stored at media content source 502 and/or server 504, and provided to devices executing a client-side portion of the VSA.

In some embodiments, server 504 may include control circuitry 511 and storage 514 (e.g., RAM, ROM, Hard Disk, Removable Disk, etc.). Storage 514 may store one or more databases. Server 504 may also include an input/output (I/O) path 512. I/O path 512 may provide device information, and/or other data, over a local area network (LAN) or wide area network (WAN), and/or other content and data to control circuitry 511, which may include processing circuitry, and storage 514. Control circuitry 511 may be used to send and receive commands, requests, and other suitable data using I/O path 512, which may comprise I/O circuitry. I/O path 512 may connect control circuitry 511 (and specifically processing circuitry thereof) to one or more communications paths.

Control circuitry 511 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 511 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 511 executes instructions for a VSA stored in memory (e.g., the storage 514). Memory may be an electronic storage device provided as storage 514 that may be part of control circuitry 511.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 504), which may be located centrally or at distributed locations, that provide cloud-based services to various types of users and devices connected via a network such as the Internet via communication network 506. In such embodiments, user equipment devices may operate in a peer-to-peer manner without communicating with a central server. Device 508 may be a cloud client that relies on the cloud computing capabilities from server 504 to perform one or more of the functions described herein.

User equipment device 508 may comprise control circuitry 526. In some embodiments, microphone 529 may receive voice commands for the VSA. In some embodiments, display 520 may be a television display or a computer display. In some embodiments, user input interface 518 may be a remote control device. In some embodiments, the circuit boards may include control circuitry, processing circuitry, and storage (e.g., RAM, ROM, hard disk, removable disk, etc.). In some embodiments, the circuit boards may include an input/output path. User equipment device 508 may receive content and data via input/output (I/O) path 528. I/O path 528 may provide content (e.g., on-demand content, Internet content, content available over a local area network (LAN) or wide area network (WAN), and/or other content) and data to control circuitry 526, which may comprise processing circuitry 524 and storage 522. Control circuitry 526 may be used to send and receive commands, requests, and other suitable data using I/O path 528, which may comprise I/O circuitry. I/O path 528 may connect control circuitry 526 (and specifically processing circuitry 524) to one or more communications paths (described below). I/O functions may be provided by one or more of these communications paths, but are shown as a single path in FIG. 5 to avoid overcomplicating the drawing. Device 508 and/or vehicle 530 may include a camera, which may comprise any suitable image capture device and/or video camera integrated with the equipment or externally connected. Camera may be a digital camera comprising a charge-coupled device (CCD) and/or a complementary metal-oxide semiconductor (CMOS) image sensor. The camera may be an analog camera that converts to digital images via a video card.

Control circuitry 526 may be based on any suitable control circuitry such as processing circuitry 524. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 526 executes instructions for the VSA stored in memory (e.g., storage 522). Specifically, control circuitry 526 (and/or control circuitry 532 of vehicle 530) may be instructed by the VSA to perform the functions discussed above and below. In some implementations, processing or actions performed by control circuitry 526 may be based on instructions received from the VSA.

The instructions for performing any of the embodiments discussed herein of the VSA may be encoded on non-transitory computer-readable media (e.g., a hard drive, random-access memory on a DRAM integrated circuit, read-only memory, etc.). For example, in FIG. 5, the instructions may be stored in storage 514 and 522, and executed at least in part by by control circuitry 511 and 526, respectively, of server 504 and/or device 508 (and/or the instructions may be stored at storage 534 of vehicle 530 and executed at least in part by control circuitry 532 of vehicle 530).

In client/server-based embodiments, control circuitry 526 may include communications circuitry suitable for communicating with a VSA server or other networks or servers. The instructions for carrying out the above mentioned functionality may be stored on a server and/or client devices. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device provided as storage 522 that is part of control circuitry 526. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 522 may be used to store various types of content described herein as well as VSA described above. Nonvolatile memory may also be used (e.g., to launch a boot-up routine and other instructions). Cloud-based storage, described in relation to FIG. 5, may be used to supplement storage 522 or instead of storage 522.

Control circuitry 526 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 526 may also include scaler circuitry for upconverting and downconverting content into the preferred output format of user equipment device 508. Control circuitry 526 may also include digital-to-analog converter circuitry and analog-to-digital converter circuitry for converting between digital and analog signals. The tuning and encoding circuitry may be used by user equipment device 508 to receive and to display, to play, or to record content. The tuning and encoding circuitry may also be used to receive VSA data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 522 is provided as a separate device from user equipment device 508, the tuning and encoding circuitry (including multiple tuners) may be associated with storage 522.

Control circuitry 526 may receive instruction from a user by way of user input interface 518. User input interface 518 may be any suitable user interface, such as a remote control, mouse, trackball, keypad, keyboard, touch screen, touchpad, stylus input, joystick, voice recognition interface, or other user input interfaces. Display 520 may be provided as a stand-alone device or integrated with other elements of each one of user equipment device 508. For example, display 520 may be a touchscreen or touch-sensitive display. In such circumstances, user input interface 518 may be integrated with or combined with display 520. Display 520 may be one or more of a monitor, a television, a display for a mobile device, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to display 520. The video card may be any control circuitry described above in relation to control circuitry 526. The video card may be integrated with control circuitry 526. Speakers 516 may be provided as integrated with other elements of each one of user equipment device 508 or may be stand-alone units. The audio component of videos and other content displayed on display 520 may be played through the speakers 516. In some embodiments, the audio may be distributed to a receiver (not shown), which processes and outputs the audio via speakers 516. In some embodiments, headphones or ear pods may be employed to provide audio to occupants, passengers, or future passengers of a vehicle associated with the VSA.

The VSA may be implemented using any suitable architecture. For example, it may be a stand-alone application (e.g., the VSA) wholly-implemented on vehicle 530 and/or user equipment device 508. In such an approach, instructions of the application (e.g., the VSA) are stored locally (e.g., in storage 522), and data for use by the application is downloaded on a periodic basis (e.g., from an out-of-band feed, from an Internet resource, or using another suitable approach). Control circuitry 526 may retrieve instructions of the application (e.g., the VSA) from storage 522 and process the instructions to provide supplemental content as discussed. Based on the processed instructions, control circuitry 526 may determine what action to perform when input is received from user input interface 518. For example, movement of a cursor on a display up/down may be indicated by the processed instructions when user input interface 518 indicates that an up/down button was selected.

In some embodiments, the VSA is a client/server-based application. Data for use by a thick or thin client implemented on each one of user equipment device 508 is retrieved on-demand by issuing requests to a server remote to each one of user equipment device 508. In one example of a client/server-based application, control circuitry 526 runs a web browser that interprets web pages provided by a remote server. For example, the remote server may store the instructions for the application in a storage device. The remote server may process the stored instructions using circuitry (e.g., control circuitry 511) to perform the operations discussed in connection with FIGS. 1-7 and generate the displays discussed above and below. The client device may receive the displays generated by the remote server and may display the content of the displays locally on device 508 This way, the processing of the instructions is performed remotely by the server while the resulting displays (e.g., that may include text, a keyboard, or other visuals) are provided locally on device 508. Device 508 may receive inputs from the user via input interface 518 and transmit those inputs to the remote server for processing and generating the corresponding displays.

Control circuitry may allow a user to provide user profile information or may automatically compile user profile information. For example, the control circuitry may access and monitor network data, video data, audio data, processing data, participation data from a conference participant profile. The control circuitry may obtain all or part of other user profiles that are related to a particular user (e.g., via social media networks), and/or obtain information about the user from other sources that control the circuitry may access. As a result, a user can be provided with a unified experience across the user's different devices.

In some embodiments, the VSA may be downloaded and interpreted or otherwise run by an interpreter or virtual machine (e.g., run by control circuitry 532 and/or run by control circuitry 526). In some embodiments, the VSA may be encoded in the ETV Binary Interchange Format (EBIF), received by control circuitry 532 and/or run by control circuitry 526 as part of a suitable feed, and interpreted by a user agent running on control circuitry 526. For example, the application may be an EBIF application. In some embodiments, the application may be defined by a series of JAVA-based files that are received and run by a local virtual machine or other suitable middleware executed by control circuitry 532 and/or run by control circuitry 526. In some of such embodiments (e.g., those employing MPEG-2 or other digital media encoding schemes), the VSA may be, for example, encoded and transmitted in an MPEG-2 object carousel with the MPEG audio and video packets of a program.

System 500 may comprise one or more vehicles 530 (which may correspond to vehicle 130 of FIG. 1). Vehicle 530 may comprise control circuitry 532, storage 534, communications circuitry 536, vehicle sensors 538, display 539, I/O circuitry 540, GPS module 542, speaker 544, and microphone 546. In some embodiments, control circuitry 532, storage 534, communications circuitry 536, display 539, I/O circuitry 540, speaker 544, and microphone 546 may be implemented in a similar manner as discussed in connection with corresponding components of server 504 and/or user equipment device 508. In some embodiments, communications circuitry 536 may be suitable for communicating with a VSA server or other networks or servers or external devices (e.g., via one or more antennas provided on an exterior or interior of vehicle 530) In some embodiments, communications circuitry 536 may be included as part of control circuitry 532.

In some embodiments, GPS module 542 may be in communication with one or more satellites or remote servers to enable vehicle 530 to provide upcoming directions, e.g., recited via speaker 544 and/or provided via display 539, to aid in vehicle navigation. In some embodiments, vehicle 530 is an autonomous or semi-autonomous vehicle capable of automatically (or semi-autonomously) navigating vehicle 530 along a route corresponding to the directions received via GPS module 542.

In some embodiments, vehicle sensors 538 may comprise one or more of proximity sensors, ultrasonic sensors, temperature sensors, accelerometers, gyroscopes, pressure sensors, humidity sensors, image sensors, seat sensors, precipitation sensors, ambient temperature sensors (for an environment internal to the vehicle and/or external to the vehicle), and/or any other suitable sensors. In some embodiments, vehicle sensors 538 may include, e.g., the sensors discussed in relation to car sensor manager 408 of FIG. 4, and/or any other suitable sensors discussed herein. In some embodiments, control circuitry 532 may monitor vehicle operations, such as navigation, powertrain, braking, battery, generator, climate control, and other vehicle systems. Such communication systems for exchanging information with external devices, networks, and systems, such as cellular, Wi-Fi, satellite, vehicle-to-vehicle communications, infrastructure communication systems, and other communications technologies. Such vehicle systems may acquire numerous data points per second, and from this data may identify or calculate numerous types of vehicle status data, such as location, navigation, environmental conditions, velocity, acceleration, change in altitude, direction, and angular velocity. In some embodiments, information collected by vehicle 530 may be utilized by vehicle 530 and/or transmitted to server 504 for use in performing autonomous or semi-autonomous navigation.

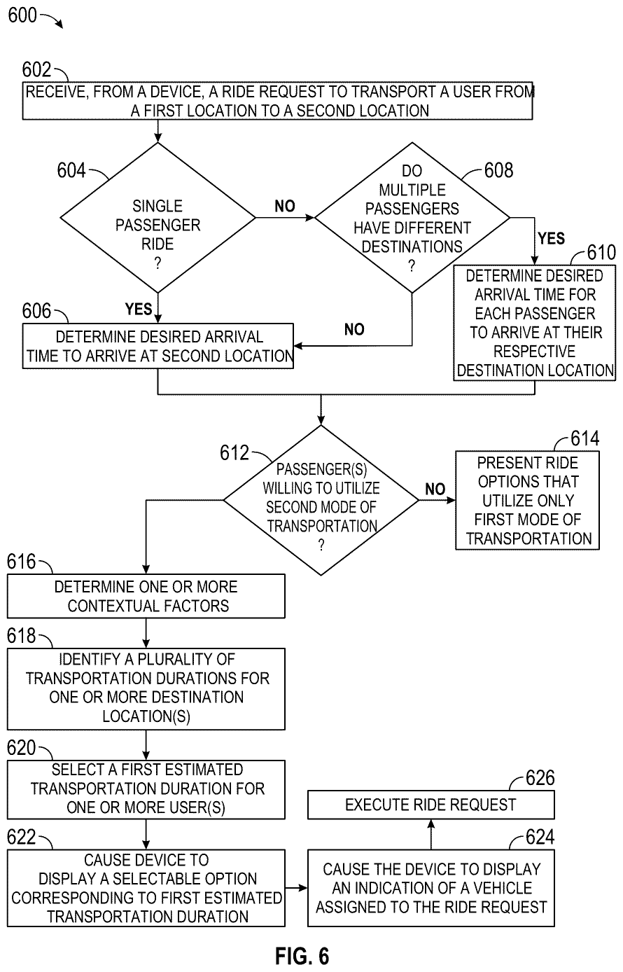

FIG. 6 is a flowchart of a detailed illustrative process 600 for providing a transportation option, in accordance with some embodiments of this disclosure. In various embodiments, the individual steps of process 600 may be implemented by one or more components of the devices, methods, and systems of FIGS. 1-5 and may be performed in combination with any of the other processes and aspects described herein. Although the present disclosure may describe certain steps of process 600 (and of other processes described herein) as being implemented by certain components of the devices, methods, and systems of FIGS. 1-5, this is for purposes of illustration only, and it should be understood that other components of the devices, methods, and systems of FIGS. 1-5 may implement those steps instead. The steps of FIG. 6 may be performed, for example, by control circuitry (e.g., control circuitry 526 of user equipment device 508, control circuitry 511 of server(s) 504, and/or control circuitry 532 of vehicle 530), and/or using I/O circuitry (distinct from or included in the control circuitry), communication circuitry (distinct from or included in the control circuitry), and/or any other suitable circuitry of device 508, server(s) 504, and vehicle 530) At 602, the control circuitry may receive, from a device (e.g., device 102 of FIG. 1) a ride request to transport a user from a first location (e.g., pickup location 104 of FIG. 1) to a second location (e.g., destination location 106 of FIG. 1). For example, such request may be received by way of one or more networks at a server (e.g., server 504 of FIG. 5) from the device.

At 604, the control circuitry may determine whether the ride request is associated with a single passenger, or multiple passengers. This may be determined based on information included with the request, or based on analyzing other data (e.g., an email indicating that multiple users in a same family are heading to a sporting event together). In some embodiments, this may be determined at least in part on car sensors, e.g., when users enter or are visible to a vehicle associated with the ride request. If the ride is determined to be a single ride request, processing may proceed to 606; otherwise processing may proceed to 608. At 608, the control circuitry may determine whether the multiple passengers associated with the ride request have different destinations. For example, if the ride request is a ride share scenario where at least two passengers are carpooling, may not know each other, and are heading to different destinations, processing may proceed to 610. Otherwise, if each passenger has the same destination, processing may proceed to 608.

At 606, the control circuitry may determine a desired arrival time to arrive at a second location. For example, such information may be received via input, as shown at 108, or may otherwise be determined based on, e.g., information in an email, text message or other electronic message associated with one or more users (e.g., user 101) having requested the ride, such as, for example, information indicating a restaurant reservation start time, or any other suitable data. In some embodiments, the desired arrival time may correspond to a fastest possible arrival time. In some embodiments, the control circuitry may cause display of a prompt to have the user confirm such desired arrival time for one or more users. At 610, the control circuitry may perform similar processing to that of 606 for the multiple users traveling to different destinations.

At 612, the control circuitry may determine whether at least one passenger in the vehicle is willing to utilize a second mode of transportation for at least a portion of the journey from the first location to the second location (and which is still estimated to allow the user to arrive by their desired arrival time(s)). For example, a first mode of transportation may be a car that is to drive the user(s) at a least a portion (e.g., a majority) of the ride, and a second mode of transportation may be, for example, a user utilizing one or more of walking, using public transportation, another car, a scooter, or any other suitable mode of transportation, to travel to their final destination location. If each user of multiple users to be present in the vehicle associated with the ride request is traveling to the same destination, the control circuitry may determine whether all users, a majority of the users, or a user having a higher priority, is willing to utilize the second mode of transportation.

At 612, the willingness to utilize a second mode of transportation may be based on, for example, explicit user input (e.g., indicating a willingness to walk at least a certain amount of time or a maximum amount of time), analyzing a user's historical willingness or tendency to utilize a second mode of transportation, a user's demographics or fitness level, and/or any other suitable factors. If, at 612, the passenger(s) of the vehicle are determined as unwilling to utilize a second mode of transportation, processing may proceed to 614, where the control circuitry may present ride options which utilize only the first mode of transportation (e.g., which pickup and drop off the user in a car or truck associated with the VSA as close as possible to the respective pickup location 104 and destination location 106). Otherwise, processing may proceed to 616.

At 616, the control circuitry may determine one or more contextual factors associated with the ride request, such as, for example, a current weather condition. For example, if it is currently raining or snowing, and/or a temperature is below a threshold (e.g., 45 degrees Fahrenheit), it may be undesirable for a user to utilize a second mode of transportation. In some embodiments, a tolerance for a duration or distance of the second mode of transportation (e.g., walking) may scale in association with changes in temperature (or other environmental conditions, such as precipitation, cloud cover, etc.). For example, a user may be willing to walk up to 30 minutes when the temperature is above 60 degrees F. and no precipitation is present.

They might be unwilling to walk when the temperature is below 40 degrees F. Thus, when the temperature is 50 degrees F., the system may infer that the passenger is willing to walk for a duration of up to 15 minutes. In some embodiments, this may be factored into the determination at 612. In some embodiments, the control circuitry may determine and/or receive data in relation to one or more contextual factors in relation to the one or more navigation routes, e.g., anticipated and/or real-time contextual factors, such as, for example, traffic conditions; roadwork; construction; a parade or other event; a street closure; a flooded road; a traffic light with historically lengthy wait times; police activity; accident or other obstacle along the respective route; the nature of the roads along the route (e.g., one-way roads) including roads proximate to the destination location 106; weather or other environmental conditions; a scheduled or predicted next trip of a driver of the vehicle (as described in relation to FIG. 2); and/or any other suitable factors.

At 618, the control circuitry may determine a plurality of transportation durations for one or more destination locations of the one or more passengers. For example, the determination at 616 may be based at least in part on the processing at 612 and 616. In some embodiments, each of the plurality of estimated transportation durations respectively corresponds to one or more drop-off locations at or within a proximity of the second location. In some embodiments, each of the plurality of estimated transportation durations is based at least in part on a first mode of transportation associated with the ride request transporting the user from the first location to the respective drop-off location and enables the user to arrive at the second location by the desired arrival time (e.g., 5 PM, as indicated at 108 of FIG. 1).

In some embodiments, one or more of the plurality of estimated transportation durations (e.g., the first transportation duration) may additionally or alternatively be associated with pickup locations at or proximate to the first location (e.g., pickup location 104 of FIG. 1). For example, the control circuitry may determine, e.g., based at least in part on the contextual factors described herein and identified at 616, that a pickup location a few blocks away from the pickup location 104 (e.g., a current location of the user) would be preferable for the vehicle of the VSA platform as compared to pickup location 104 in terms of saving time for the driver of the VSA platform and/or the requesting user (e.g., the user walking a few blocks from location 104 may help avoid traffic or road closures or other obstacles which are determined as likely to be present if pickup location 104 were utilized). In some embodiments, each of the plurality of estimated transportation durations respectively corresponds to one or more pickup locations at or within a proximity of the first location (e.g., pickup location 104). In some embodiments, each of the plurality of estimated transportation durations is based at least in part on a first mode of transportation associated with the ride request transporting the user from the pickup location (e.g., a few blocks away from pickup location 104) to the destination location (or a drop-off location proximate to the destination location) and enables the user to arrive at the second location by the desired arrival time (e.g., 5 PM, as indicated at 108 of FIG. 1).

At 620, the control circuitry may select a first estimated transportation duration of the plurality of transportation durations for the one or more users. For example, in the example of FIG. 1, the control circuitry may identify (and output information indicative of, ride option 114 and ride option 116). The control circuitry may select ride option 114, which may be a “walk and save” ride, in which a first mode of transportation (e.g., a RHRS vehicle) may pick up the user at pickup location 104, and drop off the user at drop-off location 120 (e.g., a 3-minute walk from destination location 124). On the other hand, ride option 116 may be a “door-to-door” ride which, in comparison to ride option 114, takes longer for a vehicle to arrive, and drops the user off later at the destination than if the user walked from drop-off location 120 to the destination. For example, as shown in FIG. 1, the control circuitry may estimate that the traffic on elm street 124 would cause navigation to a front door of destination location 106 to have an estimated transportation duration that exceeds navigation to drop-off location 120 in conjunction with walking (or another mode of transportation) from drop-off location 120 to destination location 124. For example, for roads proximate to the pickup location and/or destination location, a walking distance may be compared to a distance which would have to be traversed in the vehicle in current traffic conditions.

In some embodiments, for multiple passengers having different destinations, multiple drop-off locations may be determined for each respective passenger, or a single drop-off location may be determined for each of the passengers. For example, if each of the passengers have a destination of a particular airport, albeit different terminals, the control circuitry may determine a drop-off location to efficiently allow each passenger to arrive at their respective terminal, e.g., a location in between the two terminals from which each user may walk to their terminal. As another example, one user may be prioritized, e.g., based on having an earlier flight time, or other data (e.g., based on having TSA pre-check or a priority status on their airline) or based on which terminal has a longer security line, to determine who is to be dropped off first at their respective terminal. In some embodiments, the VSA may have a partnership with an airline, to help acquire this priority information, and/or such data may be obtained via an email or other electronic message associated with the user. As another example, the first drop-off location (e.g., terminal A or terminal B at the airport) may be selected based on a quicker route to the next drop-off location (e.g., it may be determined that dropping off a user at terminal B and then the next user at terminal A will save time as opposed to dropping off a user at terminal A and then the next user at terminal B, based on the layout of the airport terminals and roads leading thereto).

At 622, the control circuitry may cause a device (e.g., device 102 of FIG. 1) to display a selectable option (e.g., option 114) corresponding to the first estimated transportation duration. In some embodiments, the control circuitry may present the driver or passenger with multiple potential drop off/pickup locations and enable them to select one, and each potential location may be marked with the amount of time it saves the driver, passenger, or total travel time.

At 624, based at least in part on receiving selection of the selectable option, causing the device to display an indication of a vehicle (e.g., vehicle 130 of FIG. 1) and/or driver (e.g., indicated at 126 of FIG. 1) assigned to the ride request to pick up the user at the first location and execute a transportation route (e.g., indicated at 132 of FIG. 1) to transport the user to the first drop-off location (e.g., drop-off location 120 of FIG. 1) associated with the first estimated transportation duration. At 626, the vehicle may be caused to execute the ride request, after picking up the passenger(s), according to the transportation route and the selected drop-off location(s). In some embodiments, while the vehicle is traveling along the transportation route, if conditions change (e.g., it begins raining, or traffic becomes heavier or lighter on certain roads proximate to the destination), the passenger and/or driver may be prompted to change the drop-off location (and/or the drop-off location may automatically be changed). In some embodiments, while the vehicle is traveling along the transportation route, a subsequent ride accepted by the driver may cause the drop-off location to be changed, e.g., to set the driver up to arrive at the next pickup location faster, while minimizing the inconvenience to the current passenger.

In some embodiments, the techniques of FIG. 6 may be used to select a combination of passengers to be assigned to a same vehicle, e.g., based on the passenger's willingness to utilize alternative modes of transportation in conjunction with the ride share vehicle, and such user's drop-off locations and the projected route between such locations.

In some embodiments, the techniques of FIG. 6 may be used in more casual driving scenarios, e.g., a person driving their family or friends to a destination, even if no compensation is to be provided to the driver. In some embodiments, the control circuitry may determine that the driver will have a next destination even if they have not selected one. Such a determination may be based on travel history (e.g., the driver often picks up food from a location and then drives home), driver and passenger identity (e.g., the driver often drops off their son at grade school, then their daughter at high school, then drives home), or available user information (e.g., a takeout order has been placed). In this case, the control circuitry may select the drop off/pickup location that best fits the predicted next destination. The control circuitry may select a drop off/pickup location based on its confidence in the predicted next destination candidates. For example, if the control circuitry is 60% confident that a user will drive home after the next destination and 30% confident they will drive to their favorite bar, it may select a drop off location that is convenient for both locations and if possible, more convenient for the destination with more confidence.

In some embodiments, the techniques of FIG. 6 may be used in relation to providing a delivery service (e.g., package or food deliveries). In this scenario, the delivery driver may be assumed to be willing to walk, or employ any mode of transportation in addition to their primary mode of transportation (e.g., vehicle or bicycle) to deliver food or other package to a customer as quickly as possible. Since the driver would be the one walking in this scenario, the control circuitry may determine whether a round trip walk time (e.g., from the driver's vehicle to the customer's location and back) in combination with the time estimated to arrive at the location where the vehicle is park, exceeds the estimated time for navigating entirely or substantially entirely to the customer's location using the first mode of transportation.

In some embodiments, contextual factors such as, for example, weather or weight of the package may be considered (e.g., a package above a threshold weight of, for example, 15 pounds, might (depending on the delivery driver's age or fitness level) have to be carried from the vehicle as close as possible to the customer's address, even if walking from a nearby drop-off location might save time). As another example, the control circuitry may determine how subsequent food or package deliveries for customers at other locations might be impacted, e.g., if their expected delivery time is estimated to still be met, if the delivery driver utilizes a second mode of transportation for a prior delivery, and/or if multiple deliveries can be made prior to the driver returning to their vehicle. In some embodiments, the nature of the delivery (e.g., a hot dish or a cold dish) may be taken into account, e.g., to prioritize delivery of a hot food item over the cold food item amongst customers.

FIG. 7 shows illustrative data which may be used for providing transportation options, in accordance with some embodiments of this disclosure. FIG. 7 shows data for two users 701 and 711 in a ride share scenario. For example, users 701 and 711 may have been assigned to the same vehicle of the VSA platform as part of a request to navigate to a same location (e.g., Smith Airport indicated at 706, albeit different terminals), have requested to be assigned to a same vehicle of the VSA platform to travel to the location indicated at 706, and/or are currently in such vehicle traveling to the location indicated at 706. For example, a user device 702 of user 701, or a user device 704 of user 711, may, based on user input, transmit a request to the VSA to request a ride. Such request may explicitly indicate that each of users 701 and 711 will be getting in the vehicle, or sensor data (e.g., received from sensors of the vehicle or a device present in the vehicle) may indicate that multiple users are getting in the vehicle. The information shown on the interface of device 702, and the information shown on the interface of device 704, may be manually, voluntarily, or automatically shared with the VSA, e.g., directly by the airlines, or by the respective users, or the VSA may, for example, have permission to scan the email accounts or other electronic messages associated with user devices 702 and 704, respectively to acquire such information. In some embodiments, to ascertain an identity of users entering the vehicle, user devices 702 and 704 may transmit an indication to the VSA vehicle of their entry into the vehicle, locations of such user devices 702 and 704 may be taken into account, image data of such users may be captured an analyzed, and/or any other suitable technique may be employed.

As shown in FIG. 7, flight details 705 for the user indicated at 701 may indicate a location (e.g., airport) 706 for the user's upcoming flight; a terminal and airline 708 for the user's upcoming flight; boarding, takeoff, and flight timing status information 710; whether the user 701 has TSA status; a projected security wait time 714 for the flight; whether the user 701 has a royalty status with the airline (“First Airline”) 716; and/or any other suitable flight data. Similarly, flight details 715 for the user indicated at 703 may indicate a location (e.g., airport) 706 for the user's upcoming flight; a terminal and airline 718 for the user's upcoming flight; boarding, takeoff, and flight timing status information 720; whether the user 711 has TSA status; a projected security wait time 724 for the flight; whether the user 701 has a royalty status with the airline (“Second Airline”) 726; and/or any other suitable flight data.

Such flight data may be communicated to the VSA based on communication channels (e.g., over the Internet) between the respective airlines (e.g., “First Airline” and “Second Airline” shown in FIG. 7) and the VSA (e.g., databases or servers of the VSA and airlines may share data of user profiles). For example, the VSA may have agreements or partnerships with the airlines, to help facilitate the acquisition of the flight information shown in FIG. 7, and/or such data may be obtained via an email or other electronic message associated with the user. In some embodiments, a profile of the user with the airline may be associated with a profile of the user with the VSA, to facilitate the sharing of the flight information shown in FIG. 7.

In determining whether to drop off user 701 or user 711 first (and which locations each user should be dropped off at), or whether to drop off user 701 or user 711 at a same location (and if so, what location that should be), the VSA may consider one or more of a variety of factors. For example, the VSA may determine, based on a current time, one or more contextual factors of a route between a pickup location of users 701 and 711 and the airport, and/or any other suitable factors, a plurality of estimated transportation durations to enable user 701 and 711 to arrive at their airport terminal at a desired arrival time. Such a desired arrival time may be based on input explicitly received from user 701 or user 711, or based on an assumption that users tend to prefer to arrive at least a certain amount of time (e.g., one hours) before their flight boards. For example, a desired arrival time for user 701 may be 11:30 AM on Mar. 25, 2025, and a desired arrival time for user 711 may be 11:20 AM on Mar. 25, 2025, each being one hour before their respective flight times.

Based on the plurality of estimated transportation durations to enable user 701 and 711 to arrive at their airport terminal at their desired arrival times, the VSA may determine a plurality of drop-off locations at or proximate to terminal 1 or terminal 2 of the Smith Airport indicated at 706. For example, the VSA may determine that, given current traffic conditions between terminal 1 and terminal 2, a time remaining until boarding and/or flight takeoff times, a projected security line wait, a walking distance between terminal 1 and terminal 2, and/or any other suitable factors, user 711 would be able to arrive at terminal 2 at an earlier time if user 711 is also dropped off at terminal 1 with user 701 by the VSA vehicle, and then user 711 subsequently walking from terminal 1 to terminal 2, as opposed to dropping user 711 at the entrance of terminal 2. The VSA may additionally or alternatively determine that dropping both users off at terminal 1 would benefit the driver and/or VSA vehicle by allowing the vehicle to avoid traffic, even if user 711 would otherwise arrive later than if driven to the entrance of terminal, e.g., provided user 711 is expected to arrive by their desired arrival time after walking from terminal 1 to terminal 2.

In some embodiments, certain factors may be determinative, or each factor may be assigned the same or different weights, in terms of helping decide a drop-off location. For example, in some embodiments, since user 701 has royalty status 716 with the first airline, a transportation option may be selected that allows user 701 to get to their airport terminal as fast as possible, and that aligns with such user preferences, e.g., no willingness to walk. As another example, whether a user has TSA status, in some circumstances, may weigh in favor of prioritizing getting that user to their terminal as soon as possible, or in other circumstances, may indicate that their security line length is less of a concern, so there may be more leeway to identify a route with multiple modes of transportation. As another example, in some embodiments, helping a user, such as user 711, avoid missing their flight may be prioritized, regardless of the status of the other user 701 in the vehicle. For example, the VSA may estimate that a transportation route (in which user 711 is transported by the VSA vehicle to the airport and then walks or utilizes another mode of transportation from terminal 1 to terminal 2) will take 40 minutes from current time 703 (10:45 AM), which would cause the estimated arrival time of user 711 to be at 11:25 PM. The VSA may determine that, since such projected time of 12:25 PM is after the desired arrival time of 11:20 AM is prior to the 11:25 expected arrival for such transportation route, another route should be selected (e.g.,. dropping off user 711 at the entrance of terminal 2) to allow the desired arrival time to be met. As another example, in addition or in the alternative to taking into account the desired time of arrival at the airport terminal, the projected time of getting through security may be taken into account. For example, if the estimated time to get through security (e.g., 15 minutes) for user 711, added to an estimated arrival time of arriving at terminal 2 is within a threshold period of time (e.g., 15 minutes) from the boarding time or flight time, a transportation route that allows user 711 to arrive at their terminal as soon as possible may be selected, even if it slightly inconveniences user 701, e.g., to be dropped off after at terminal 1, or to have to walk from terminal 2 to terminal 1.

The VSA may use vehicle sensors to detect, in real-time, passengers getting in or getting out of the vehicle, and may automatically adjust one or more of the transportation routes to be executed by the vehicle. For example, a transportation route for users 701 and 711 of FIG. 7 may be dynamically altered based on changed conditions, e.g., detected during the ride. For example, if the VSA determines (e.g., based on sensor data or user input of the passengers or driver) that one of the users has exited the vehicle (e.g., user 701 has to miss their flight for an unforeseen circumstance that came to their attention while in the vehicle, or receives an indication that their flight was canceled while in the vehicle), the VSA may dynamically determine an updated transportation route, which may different from the initially determined transportation route. For example, even if user 701 exits the vehicle, depending on contextual factors and/or preferences of user 711, it may still be desired to drop user 711 off from the VSA vehicle at terminal 1, and allow user 711 to walk to terminal 2, e.g., based on a willingness to walk on the part of user 711. On the other hand, if user 701 exits the vehicle, depending on contextual factors and/or preferences of user 711, it may be desired to instead drop user 711 off from the VSA vehicle at or closer to terminal 2, since user 701 having their flight at terminal 1 is no longer a consideration for the ride request. As another example, if there is an obstacle or heavy traffic at terminal 1, preventing or hindering access to terminal 1 and/or terminal 2 by the VSA vehicle, the VSA may determine (e.g., in real-time) a drop-off location at a location proximate to terminal 1 and terminal 2, estimated to allow the users to, e.g., walk or jog, to their destination by their desired arrival times.

As another example, if one or more users also specifying a desired destination as airport 706 enters the vehicle, in addition to users 701 and 711, flight information for such one or more users may be taken into consideration. For example, if a third user also has a flight at terminal 2, the VSA may determine, based at least in part on this information, to have a single drop-off location at terminal 2, to allow more of the passengers (e.g., 2 out of 3) to be closer to their terminal when exiting the VSA vehicle, and less passengers (e.g., 1 out of 3) to utilize another mode of transportation (e.g., walk) to another terminal (e.g., terminal 1). Alternatively, if a third user also has a flight at terminal 2, and a preference of the third user indicates, e.g., a willingness to walk, the VSA may identify another user (e.g., user 711) also having a preference to walk, which may weigh in favor of a drop-off location of terminal 1, to allow 2 out of 3 of the users in the vehicle the opportunity to walk or use another mode of transportation to arrive at their terminal 2 (e.g., walk from the terminal 1 drop-off location to terminal 2).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method, comprising:
receiving, from a device, a ride request to transport a user from a first location to a second location;
determining a desired arrival time for the user to arrive at the second location;
identifying a plurality of estimated transportation durations, wherein each of the plurality of estimated transportation durations respectively corresponds to one or more drop-off locations at or within a proximity of the second location, and wherein each of the plurality of estimated transportation durations is based at least in part on a first mode of transportation associated with the ride request transporting the user from the first location to the respective drop-off location and enables the user to arrive at the second location by the desired arrival time;
selecting a first estimated transportation duration of the plurality of estimated transportation durations which is:
associated with a first drop-off location; and
based at least in part on an estimated transportation duration for the first mode of transportation to transport the user from the first location to the first drop-off location and an estimated transportation duration for a second mode of transportation to enable the user to arrive at the second location from the first drop-off location,
wherein the estimated transportation duration for the second mode of transportation associated with the first estimated transportation duration exceeds an estimated transportation duration for the second mode of transportation associated with a second estimated transportation duration of the plurality of estimated transportation durations;
based at least in part on the selecting, causing the device to display a selectable option corresponding to the first estimated transportation duration; and
based at least in part on receiving selection of the selectable option, causing the device to display an indication of a vehicle assigned to the ride request to pick up the user at the first location and execute a transportation route to transport the user to the first drop-off location associated with the first estimated transportation duration.

2. The method of claim 1, further comprising:
predicting a pickup location for a predicted subsequent ride request, wherein the vehicle is predicted to navigate to the predicted pickup location after the first mode of transportation associated with the ride request is completed; and
causing the device to display the selectable option corresponding to the first estimated transportation duration based at least in part on determining that an estimated travel time for the vehicle to travel from the first drop-off location to the predicted pickup location is less than an estimated travel time for the vehicle to travel from a second drop-off location, associated with the second estimated transportation duration, to the predicted pickup location.

3. The method of claim 1, further comprising:
while the vehicle is transporting the user to the first drop-off location, identifying a pickup location for a subsequent ride request, wherein the vehicle is to navigate to the pickup location after the vehicle transportation of the user associated with the ride request is completed; and
modifying the transportation route to indicate that the user is to be dropped off at a second drop-off location instead of the first drop-off location, based at least in part on determining that an estimated travel time for the vehicle to travel from the second drop-off location to the pickup location for the subsequent ride request is less than an estimated travel time for the vehicle to travel from the first drop-off location to the pickup location for the subsequent ride request.

4. The method of claim 1, wherein the user is a first user, and the ride request is further associated with a second user to be picked up at the first location with the first user and dropped off at a third location different from the second location, the method further comprising:
selecting the first estimated transportation duration from the plurality of estimated transportation durations based at least in part on determining that an estimated transportation duration from the first drop-off location to the third location is less than an estimated transportation duration from the other drop-off locations associated with the other of the plurality of transportation durations to the third location.

5. The method of claim 1, wherein the first mode of transportation corresponds to a vehicle, and the second mode of transportation corresponds to at least one of walking, jogging, running, or biking, wherein the selectable option is a first selectable option, the method further comprising:
causing the device to display a plurality of selectable options corresponding to the plurality of estimated transportation durations, respectively, wherein the plurality of selectable options comprises at least the first selectable option and a second selectable option corresponding to the second estimated transportation duration;
causing the device to display, in association with the first selectable option, an indication of the estimated vehicle transportation duration for the first estimated transportation duration and an indication of the estimated duration for the at least one of walking, jogging, running, or biking for the first estimated transportation duration; and
causing the device to display, in association with the second selectable option, an indication of an estimated vehicle transportation duration for the second estimated transportation duration and an indication of the estimated duration for the at least one of walking, jogging, running, or biking for the second estimated transportation duration.

6. The method of claim 1, wherein the selectable option is a first selectable option, the method further comprising:
causing the device to display a plurality of selectable options corresponding to the plurality of estimated transportation durations, respectively, wherein the plurality of selectable options comprises at least the first selectable option and a second selectable option corresponding to the second estimated transportation duration, and wherein the first estimated transportation duration is greater than the second estimated transportation duration; and
causing the device to display a first cost associated with the first selectable option and a second cost associated with the second selectable option, wherein the first cost is less than the second cost.

7. The method of claim 1, further comprising:
causing the device to display a prompt related to a willingness to walk at least a threshold amount of time from a drop-off location to the second location; and
causing the device to display the selectable option corresponding to the first estimated transportation duration, based at least in part on receiving input, in relation to the prompt, indicating a willingness of the user to walk from a drop-off location to the second location.

8. The method of claim 1, further comprising:
causing the device to display the selectable option corresponding to the first estimated transportation duration based at least in part on identifying data associated with a profile of the user indicative of a willingness of the user to walk at least a threshold amount of time from a drop-off location to the second location.

9. The method of claim 8, further comprising:
assigning the vehicle to the ride request based at least in part on a profile associated with at least one of the vehicle or a driver of a driver of the vehicle indicating a preference for passengers that are willing to walk at least the threshold amount of time.

10. The method of claim 1, wherein:
the ride request is received by a ride hailing/ride sharing application; and
determining, based on a profile of the user, the desired arrival time for the user to arrive at the second location is based at least in part on analyzing an electronic message associated with the profile and received from an application other than the ride hailing/ride sharing application.

11. The method of claim 1, wherein determining the desired arrival time for the user to arrive at the second location comprises receiving explicit input from the user specifying the desired arrival time, in relation to the ride request.

12. The method of claim 1, wherein the user is a first user, the method further comprising:
determining that a plurality of users, including the first user, are to be transported from the first location to the second location as part of the ride request, wherein the second location is an airport, and wherein the first user of is to be dropped off at a first airport terminal of the airport, and a second user of the plurality of users is to be dropped off at a second airport terminal of the airport; and
selecting the first drop-off location as the first airport terminal based at least in part on comparing flight information for the first user and flight information for the second user.

13. The method of claim 1, further comprising:
selecting the first estimated transportation duration based at least in part on determining that the first estimated transportation duration is less than the other estimated transportation durations of the plurality of estimated transportation durations.

14. A system, comprising:
control circuitry configured to:
receive, from a device, a ride request to transport a user from a first location to a second location;
determine a desired arrival time for the user to arrive at the second location;
identify a plurality of estimated transportation durations, wherein each of the plurality of estimated transportation durations respectively corresponds to one or more drop-off locations at or within a proximity of the second location, and wherein each of the plurality of estimated transportation durations is based at least in part on a first mode of transportation associated with the ride request transporting the user from the first location to the respective drop-off location and enables the user to arrive at the second location by the desired arrival time;
select a first estimated transportation duration of the plurality of estimated transportation durations which is:
associated with a first drop-off location; and
based at least in part on an estimated transportation duration for the first mode of transportation to transport the user from the first location to the first drop-off location and an estimated transportation duration for a second mode of transportation to enable the user to arrive at the second location from the first drop-off location,
wherein the estimated transportation duration for the second mode of transportation associated with the first estimated transportation duration exceeds an estimated transportation duration for the second mode of transportation associated with a second estimated transportation duration of the plurality of estimated transportation durations;
based at least in part on the selecting, cause the device to display a selectable option corresponding to the first estimated transportation duration; and
based at least in part on receiving selection of the selectable option, cause the device to display an indication of a vehicle assigned to the ride request to pick up the user at the first location and execute a transportation route to transport the user to the first drop-off location associated with the first estimated transportation duration.

15. The system of claim 14, wherein the control circuitry is further configured to:
predict a pickup location for a predicted subsequent ride request, wherein the vehicle is predicted to navigate to the predicted pickup location after the first mode of transportation associated with the ride request is completed; and
cause the device to display the selectable option corresponding to the first estimated transportation duration based at least in part on determining that an estimated travel time for the vehicle to travel from the first drop-off location to the predicted pickup location is less than an estimated travel time for the vehicle to travel from a second drop-off location, associated with the second estimated transportation duration, to the predicted pickup location.

16. The system of claim 14, wherein the control circuitry is further configured to:
while the vehicle is transporting the user to the first drop-off location, identify a pickup location for a subsequent ride request, wherein the vehicle is to navigate to the pickup location after the vehicle transportation of the user associated with the ride request is completed; and
modify the transportation route to indicate that the user is to be dropped off at a second drop-off location instead of the first drop-off location, based at least in part on determining that an estimated travel time for the vehicle to travel from the second drop-off location to the pickup location for the subsequent ride request is less than an estimated travel time for the vehicle to travel from the first drop-off location to the pickup location for the subsequent ride request.

17. The system of claim 14, wherein the user is a first user, and the ride request is further associated with a second user to be picked up at the first location with the first user and dropped off at a third location different from the second location, and wherein the control circuitry is further configured to:
select the first estimated transportation duration from the plurality of estimated transportation durations based at least in part on determining that an estimated transportation duration from the first drop-off location to the third location is less than an estimated transportation duration from the other drop-off locations associated with the other of the plurality of transportation durations to the third location.

18. The system of claim 14, wherein the first mode of transportation corresponds to a vehicle, and the second mode of transportation corresponds to at least one of walking, jogging, running, or biking, wherein the selectable option is a first selectable option, and wherein the control circuitry is further configured to:
cause the device to display a plurality of selectable options corresponding to the plurality of estimated transportation durations, respectively, wherein the plurality of selectable options comprises at least the first selectable option and a second selectable option corresponding to the second estimated transportation duration;
cause the device to display, in association with the first selectable option, an indication of the estimated vehicle transportation duration for the first estimated transportation duration and an indication of the estimated duration for the at least one of walking, jogging, running, or biking for the first estimated transportation duration; and
cause the device to display, in association with the second selectable option, an indication of an estimated vehicle transportation duration for the second estimated transportation duration and an indication of the estimated duration for the at least one of walking, jogging, running, or biking for the second estimated transportation duration.

19. The system of claim 14, wherein the selectable option is a first selectable option, and wherein the control circuitry is further configured to:
cause the device to display a plurality of selectable options corresponding to the plurality of estimated transportation durations, respectively, wherein the plurality of selectable options comprises at least the first selectable option and a second selectable option corresponding to the second estimated transportation duration, and wherein the first estimated transportation duration is greater than the second estimated transportation duration; and
cause the device to display a first cost associated with the first selectable option and a second cost associated with the second selectable option, wherein the first cost is less than the second cost.

20. The system of claim 14, wherein the control circuitry is further configured to:
cause the device to display a prompt related to a willingness to walk at least a threshold amount of time from a drop-off location to the second location; and
cause the device to display the selectable option corresponding to the first estimated transportation duration, based at least in part on receiving input, in relation to the prompt, indicating a willingness of the user to walk from a drop-off location to the second location.

21-65. (canceled)
